(19) United States
(12) Patent Application Publication
(10) Pub. No.: US 2025/0217434 A1
(43) Pub. Date: Jul. 3, 2025

(54) PERFORMANCE OF ENERGY-BASED MODELS USING A HYBRID THERMODYNAMIC-CLASSICAL COMPUTING SYSTEM

(71) Applicant: Qyber Corp., Austin, TX (US)

(72) Inventors: Christopher Chamberland, San Antonio, TX (US); Guillaume Verdon-Akzam, Montreal (CA)

(73) Assignee: Qyber Corp., Austin, TX (US)

(21) Appl. No.: 18/480,141

(22) Filed: Oct. 3, 2023

Related U.S. Application Data
(60) Provisional application No. 63/492,171, filed on Mar. 24, 2023.

(51) Int. Cl. G06F 17/11

(52) U.S. Cl. CPC G06F 17/11

(57) ABSTRACT

Systems and methods for performing computations using both classical computing resources and a thermodynamic chip within a hybrid thermodynamic-classical computing architecture are disclosed. Classical computing resources are used to map neurons of an algorithm to physical elements of a thermodynamic chip, such as oscillators, according to a given algorithm being performed. The classical computing resources may then delegate certain portions of the algorithm to be performed using the thermodynamic chip, and subsequently receive samples throughout the evolution of said physical elements, according to Langevin dynamics. The samples may then be used to compute gradients and other relevant quantities that are part of the algorithm.

### RELATED APPLICATION

This application claims benefit of priority to U.S. Provisional Application Ser. No. 63/492,171, entitled “Hybrid Thermodynamic Classical Computing System,” filed Mar. 24, 2023, and which is incorporated herein by reference in its entirety.

### BACKGROUND

### Description of the Related Art

Various algorithms, such as machine learning algorithms, often use statistical probabilities to make decisions or to model systems. Some such learning algorithms may use Bayesian statistics, or may use other statistical models that have a theoretical basis in natural phenomena. In the execution of such algorithms, typically such statistical probabilities are calculated using classical computing devices, wherein the statistical probabilities are then used by other aspects of the algorithm. As an example, statistical probabilities may be used to generate a random number, wherein the random number is then used to evaluate some other aspect of the algorithm.

Generating such statistical probabilities may involve performing complex calculations which may require both time and energy to perform, thus increasing a latency of execution of the algorithm and/or negatively impacting energy efficiency. In some scenarios, calculation of such statistical probabilities using classical computing devices may result in non-trivial increases in execution time of algorithms and/or energy usage to execute such algorithms.

### BRIEF DESCRIPTION OF THE DRAWINGS

FIG. 1 is high-level diagram illustrating a thermodynamic chip included in a dilution refrigerator and coupled to a classical computing device in an environment (which may be in the dilution refrigerator or external to the dilution refrigerator), according to some embodiments.

FIG. 2 is a high-level diagram illustrating oscillators included in a substrate of the thermodynamic chip and mapping of the oscillators to logical neurons of the thermodynamic chip, according to some embodiments.

FIG. 3 is a high-level diagram illustrating logical relationships between neurons of the thermodynamic chip that are physically implemented via magnetic flux couplings between oscillators of the substrate of the thermodynamic chip, according to some embodiments.

FIG. 4 is a high-level diagram illustrating a pulse drive that excites oscillators and/or implements couplings between the oscillators, according to some embodiments.

FIG. 5A illustrates example couplings between visible input and visible output neurons of a thermodynamic chip, according to some embodiments.

FIG. 5B illustrates example couplings between visible input neurons, non-visible neurons, and output neurons of a thermodynamic chip, according to some embodiments.

FIG. 5C illustrates example couplings between visible neurons arranged according to a Hopfield network, according to some embodiments.

FIG. 5D illustrates example couplings between visible input neurons and non-visible neurons within given layers of a deep Boltzmann machine, implemented using a thermodynamic chip, according to some embodiments.

FIG. 6 illustrates an example configuration of neurons of a thermodynamic chip configured to perform space averaging, according to some embodiments.

FIG. 7 illustrates an example configuration for a computing system that includes a thermodynamic chip, wherein a field-programmable gate array (FPGA) is used to interface with the thermodynamic chip, and wherein the FPGA is located in an environment external to a dilution refrigerator in which the thermodynamic chip is located, according to some embodiments.

FIG. 8 illustrates an example configuration for a computing system that includes a thermodynamic chip, wherein an application specific integrated circuit (ASIC) is used to interface with the thermodynamic chip, and wherein the ASIC is located in an environment external to a dilution refrigerator in which the thermodynamic chip is located, according to some embodiments.

FIG. 9 illustrates an example configuration for a computing system that includes a thermodynamic chip, wherein a field-programmable gate array (FPGA) is used to interface with the thermodynamic chip, and wherein the FPGA is co-located in a dilution refrigerator with the thermodynamic chip, according to some embodiments.

FIG. 10 illustrates an example configuration for a computing system that includes a thermodynamic chip, wherein an application specific integrated circuit (ASIC) is used to interface with the thermodynamic chip, and wherein the ASIC is co-located in a dilution refrigerator with the thermodynamic chip, according to some embodiments.

FIG. 11 illustrates a process of training and using a thermodynamic chip to perform a portion of an algorithm, according to some embodiments.

FIG. 12 illustrates a process for executing an algorithm wherein portions of the algorithm are delegated for execution using a thermodynamic chip, according to some embodiments.

FIG. 13 is a block diagram illustrating an example computer system that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

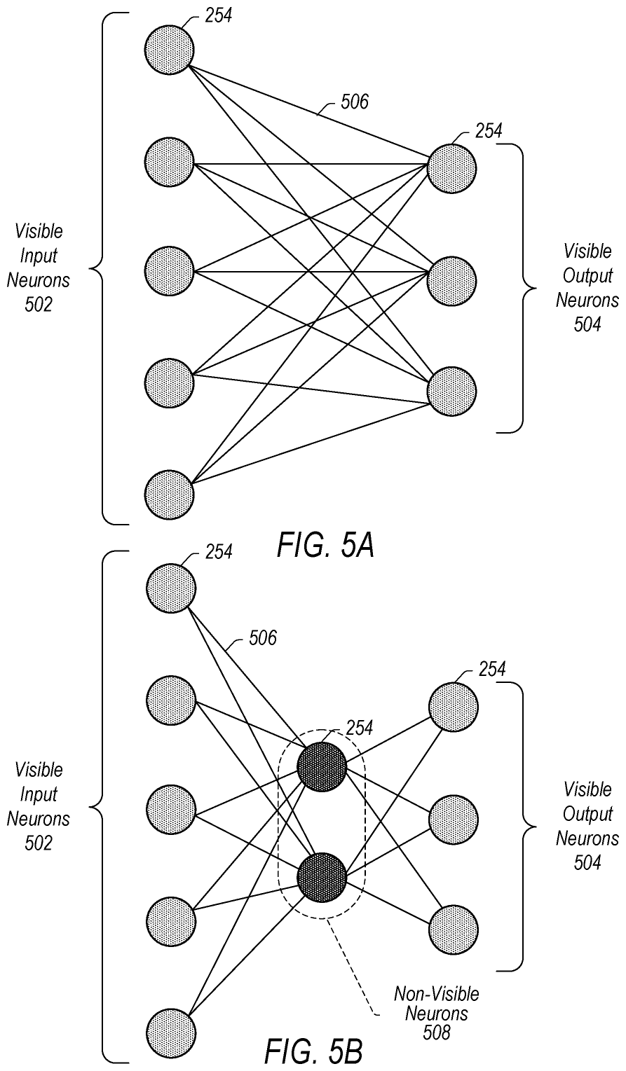

The present disclosure relates to methods, systems, and an apparatus for performing computer operations using a thermodynamic chip. In some embodiments, physical elements of a thermodynamic chip may be used to physically model evolution according to Langevin dynamics. For example, in some embodiments, a thermodynamic chip includes a substrate comprising oscillators implemented using superconducting flux elements. The oscillators may be mapped to neurons (visible or hidden) that “evolve” according to Langevin dynamics. For example, the oscillators of the thermodynamic chip may be initialized in a particular configuration and allowed to thermodynamically evolve. As the oscillators “evolve,” degrees of freedom of the oscillators may be sampled. Values of these sampled degrees of freedom may represent, for example, vector values for neurons that evolve according to Langevin dynamics. For example, algorithms that use stochastic gradient optimization and require sampling during training, such as those proposed by Welling and Teh, and/or other algorithms, such as natural gradient descent, mirror descent, etc. may be implemented using a thermodynamic chip. In some embodiments, a thermodynamic chip may enable such algorithms to be implemented directly by sampling the neurons (e.g., degrees of freedom of the oscillators of the substrate of the thermodynamic chip) directly without having to calculate statistics to determine probabilities. As another example, thermodynamic chips may be used to perform autocomplete tasks, such as those that use Hopfield networks, which may be implemented using the Welling and Teh algorithm. For example, visible neurons may be arranged in a fully connected graph (such as a Hopfield network as shown in FIG. 5C), and the values of the auto complete task may be learned using the Welling and Teh algorithm. As a particular example, instead of using a Langevin Markov Chain Monte Carlo algorithm to fully calculate given terms in the Welling and Teh algorithm using classical computing devices, such as CPU, GPUs, etc., these tasks may instead be delegated to a thermodynamic chip. This delegation may dramatically improve the calculation time of a given algorithm, such as the Welling and Teh algorithm. For example, instead of expending processing cycles to calculate the Langevin Markov Chain Monte Carlo algorithm, statistical results that approximate the Langevin Markov Chain Monte Carlo algorithm may be measured directly from the thermodynamic chip. In some embodiments, algorithms, such as Welling and Teh, natural gradient descent, and mirror descent, which require sampling during training may obtain a probability distribution from an energy based model implemented on a thermodynamic chip. Variational autoencoders may also require sampling operations, and these sampling operations can be implemented using a thermodynamic chip.

In some embodiments, a thermodynamic chip includes superconducting flux elements arranged in a substrate, wherein the thermodynamic chip is configured to modify magnetic fields that couple respective ones of the oscillators with other ones of the oscillators. In some embodiments, non-linear (e.g., anharmonic) oscillators are used that have dual-well potentials. These dual-well oscillators may be mapped to neurons of a given model that the thermodynamic chip is being used to implement. Also, in some embodiments, at least some of the oscillators may be harmonic oscillators with single-well potentials. The single-well oscillators may be mapped to non-visible (or hidden) neurons that are not mapped to input variables or output variables, but instead represent other relationships in the model, such as those that are not readily visible. In some embodiments, oscillators may be implemented using superconducting flux elements with varying amounts of non-linearity. In some embodiments, an oscillator may have a single well potential, a dual-well potential, or a potential somewhere in a range between a single-well potential and a dual-well potential. In some embodiments, both visible and non-visible neurons may be mapped to oscillators having a single well potential, a dual-well potential, or a potential somewhere in a range between a single-well potential and a dual-well potential.

In some embodiments, parameters of an energy based model or other learning algorithm may be trained by sampling the oscillators of a thermodynamic chip, that have been configured in a current configuration with couplings that correspond to a current engineered Hamiltonian being used to approximate aspects of the energy based model. Based on the sampling, a computing device coupled to the thermodynamic chip, such as a field programmable gate array (FPGA) or application specific integrated circuit (ASIC), which may be co-located in a dilution refrigerator with the thermodynamic chip, or in an external environment, external to the dilution refrigerator that hosts the thermodynamic chip, may determine updated weightings or biases to be used in the engineered Hamiltonian. In some embodiments, such measurements and updates to weightings and biases may be performed until the engineered Hamiltonian has been adjusted such that the samples taken from the thermodynamic chip satisfy one or more training criteria for training the thermodynamic chip such that the thermodynamic chip accurately implements the samples need to compute a model the thermodynamic chip is being used to approximate.

For example, in some embodiments, the engineered Hamiltonian (shown below) may be used to model a Monte Carlo sampling method and may be implemented using a thermodynamic chip wherein the first two terms of the Hamiltonian represent visible and non-visible neurons and the latter two terms of the Hamiltonian represent couplings between the weights and biases and the visible and non-visible neurons. Note that additional details regarding training and implementation of the engineered Hamiltonian to perform Bayesian learning tasks is further described herein.

$${H}_{total} = {\sum }_{j ∈ {𝒱}_{vis}} ( \frac{{p}_{{n}_{j}}^{2}}{2 {m}_{n}^{( 𝒱 )} ( t )} + {{λ}_{n}^{( 𝒱 )} ( 1 - {ω}_{n}^{( 𝒱 )} {q}_{{n}_{j}}^{2} )}^{2} ) + {\sum }_{j ∈ {𝒱}_{non - vis}} ( \frac{{p}_{{n}_{j}}^{2}}{2 {m}_{n}^{( h )} ( t )} + {{λ}_{n}^{( h )} ( 1 - {ω}_{n}^{( h )} {q}_{{n}_{j}}^{2} )}^{2} ) + ( α {\sum }_{\{ k , l \} ∈ ε} {q}_{{s}_{kl}} {q}_{{n}_{k}} {q}_{{n}_{l}} + β {\sum }_{j ∈ 𝒱} {q}_{{n}_{j}} {q}_{{b}_{j}} ) .$$

In the above equation, V represents vertices such as the neurons 254 shown in FIGS. 5A, 5B, 5C, and 5D and E represents edges that connect the vertices, also as shown in FIGS. 5A, 5B, 5C, and 5D. The neurons may be accompanied by a bias, and the synapses (weights) live on the edges. Also, note that the visible neurons may have different masses and frequencies as compared to the non-visible neurons. In some embodiments, the system may be overdamped, or underdamped. In some embodiments, the weights and biases of the engineered Hamiltonian are trained on a classical computing device, such as an FPGA or ASIC coupled with the thermodynamic chip. Measurements (e.g., samples or statistics) taken from the visible neurons (e.g., implemented as oscillators of the substrate of the thermodynamic chip) provide continuous values that correspond to degrees of freedom of the oscillators. Also, in some embodiments, the oscillators oscillate in the giga-hertz (GHz) regime. In some embodiments, measurements may be space averaged and/or time averaged (e.g., measurements made with some periodicity). Additionally, in some embodiments, measurements may also be taken from the non-visible neurons (e.g. samples or statistics), wherein the non-visible neurons are also implemented as oscillators of the substrate of the thermodynamic chip. For example, position degrees of freedom of the non-visible neurons may be measured to compute relevant gradients in a learning algorithm.

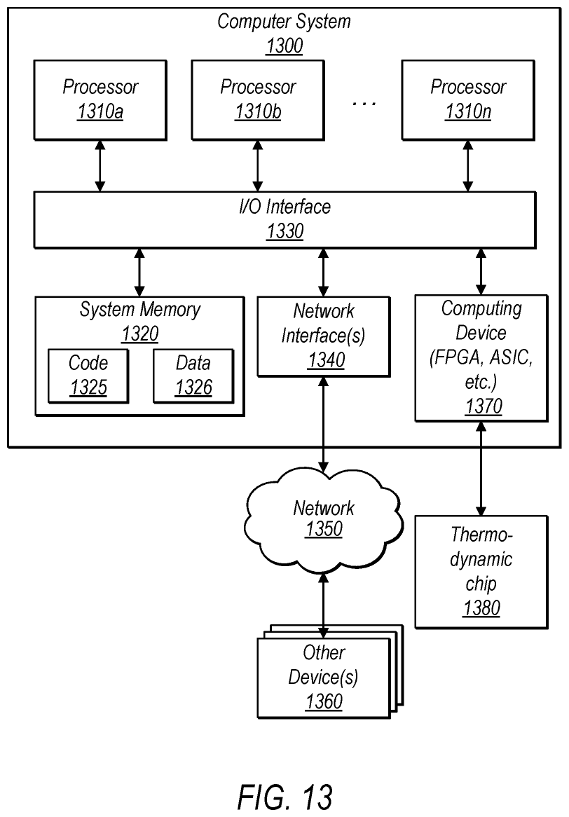

In some embodiments, the use of a thermodynamic chip in a computer system may enable a learning algorithm to be implemented in a more efficient and faster manner than if the learning algorithm was implemented purely using classical components. For example, measuring the neurons in a thermodynamic chip to determine Langevin statistics may be quicker and more energy efficient than determining such statistics via calculation (e.g., using a classical computing device). Similar benefits accrue when thermodynamic chips are used in other algorithms that have statistical sub-components such as Monte Carlo sampling methods. For example, the thermodynamic chip may function as a co-processor of a computer system, such as is shown for thermodynamic chip 1380 which is a co-processor with processors 1310 of computer system 1300 (shown in FIG. 13).

Broadly speaking, classes of algorithms that may benefit from thermodynamic chips include those algorithms that involve probabilistic inference. Such probabilistic inferences (which otherwise would be performed using a CPU or GPU) may instead be delegated to the thermodynamic chip for a faster and more energy efficient implementation. Thus, in some embodiments, a thermodynamic chip may be used to perform a sub-routine of a larger algorithm that may also involve other calculations performed on a classical computer system. At a physical level, the thermodynamic chip harnesses electron fluctuations in superconductors coupled in flux loops to model Langevin dynamics.

Note that in some embodiments, electro-magnetic or mechanical (or other suitable) oscillators may be used. A thermodynamic chip may implement neuro-thermodynamic computing and therefore may be said to be neuromorphic. For example, the neurons implemented using the oscillators of the thermodynamic chip may function as neurons of a neural network that has been implemented directly in hardware. Also, the thermodynamic chip is “thermodynamic” because the chip may be operated in the thermodynamic regime slightly above 0 Kelvin, wherein thermodynamic effects cannot be ignored. For example some thermodynamic chips may be operated at 2, 3, 4, etc. degrees Kelvin. In some embodiments, temperatures less than 15 Kelvin may be used. Though other temperatures ranges are also contemplated. This also, in some contexts, may be referred to as analog stochastic computing. In some embodiments, the temperature regime and/or oscillation frequencies used to implement the thermodynamic chip may be engineered to achieve certain statistical results. For example, the temperature, friction (e.g., damping) and/or oscillation frequency may be controlled variables that ensure the oscillators evolve according to a given dynamical model, such as Langevin dynamics. In some embodiments, temperature may be adjusted to control a level of noise introduced into the evolution of the neurons. As yet another example, a thermodynamic chip may be used to model energy models that require a Boltzmann distribution. Also, a thermodynamic chip may be used to solve variational algorithms. In some embodiments, sampling methods for sampling the thermodynamic chip are timed assuming thermal equilibrium is reached at very fast time scales, which can be in the nano-second to pico-second range.

Bayesian Learning with Energy-Based Models

As introduced above, a thermodynamic chip may be used to model energy-based models, according to some embodiments. For example, a stochastic gradient optimization algorithm, such as that of Welling and Teh, may be adapted for use in energy-based models. In such embodiments, a set of N data items X={xᵢ}ᵢ₋₁^{N} with a posterior distribution p_{θ}(x)=exp(−ε_{θ}(x))/Z(θ) and partition function Z(θ)=∫p_{θ}(x) dx may be constructed, and the Welling and Teh stochastic gradient optimization algorithm may be combined with Langevin dynamics to obtain a parameter update algorithm that provides efficient use of large datasets while also providing for parameter uncertainty to be captured in a Bayesian context. As such, the update rule may be written as

$${θ}_{t + 1} = {θ}_{t} + \frac{{ϵ}_{t}}{2} ( \frac{N}{n} {\sum }_{i = 1}^{n} {∇}_{{θ}_{t}} log {p}_{{θ}_{t}} ( {x}_{{t}_{i}} ) ) + {η}_{t} ,$$

$$with {η}_{t} ∼ N ( 0 , {ϵ}_{t} ) .$$

Furthermore, ϵₜ may be restricted to satisfy the following properties: Σₜ₌₁^{∞}ϵₜ=∞ and Σₜ₋₁^{∞}ϵₜ²<∞. With regard to the property Σₜ₋₁^{∞}ϵₜ=∞, ϵₜ may be restricted to satisfy said property in order for parameters to reach high probability regions regardless of when/where said parameters are initialized, according to some embodiments. With regard to the property Σₜ₋₁^{∞}ϵₜ²<∞, ϵₜ may be restricted to satisfy said property in order for parameters to converge to a mode instead of oscillating around said mode, according to some embodiments. A functional form which may satisfy said properties is accomplished by setting ϵₜ=a(b+t)^{-γ}, wherein, at each iteration t, a subset of data items with size n, e.g., Xₜ={xₜ_{₁}, . . . , xₜ_{ₙ}}, may be applied, and, over multiple iterations, the full data set may therefore be applied.

Continuing with the posterior distribution p_{θ}(x)=exp(−ε_{θ}(x))/Z(θ) for an energy-based model, it may be defined that

$${∇}_{θ} log {p}_{θ} ( x ) = - {∇}_{θ} {ε}_{θ} ( x ) - \frac{{∇}_{θ} Z ( θ )}{Z ( θ )} ,$$

wherein

$$\frac{{∇}_{θ} Z ( θ )}{Z ( θ )}$$

may be further defined as

$$\begin{matrix}\frac{{∇}_{θ} Z ( θ )}{Z ( θ )} = - \frac{1}{Z ( θ )} \int {∇}_{θ} {ℰ}_{θ} exp ( - {ℰ}_{θ} ( x ) ) dx \\ = - \int {∇}_{θ} {ℰ}_{θ} \frac{exp ( - {ℰ}_{θ} ( x ) )}{Z ( θ )} dx \\ = - \int ( {∇}_{θ} {ℰ}_{θ} ( x ) ) {p}_{θ} ( x ) dx \\ = - {𝔼}_{x \sim {p}_{θ} ( x )} [ {∇}_{θ} {ℰ}_{θ} ( x ) ] .\end{matrix}$$

Therefore, applying the above equations, θₜ₊₁ may be rewritten as

$${θ}_{t + 1} = {θ}_{t} - \frac{{ϵ}_{t}}{2} N ( \frac{1}{n} {\sum }_{i = 1}^{n} {∇}_{{θ}_{t}} {ℰ}_{{θ}_{t}} ( {x}_{{t}_{i}} ) - {𝔼}_{x \sim {p}_{{θ}_{t}} ( x )} [ {∇}_{{θ}_{t}} {ℰ}_{{θ}_{t}} ( x ) ] ) + {η}_{t} ,$$

according to some embodiments.

In some embodiments, in order to efficiently compute the term [symbol] _{x˜p}_{_{θ}}₍ₓ₎[∇_{θ}ε_{θ}(x)] defined above, a Langevin Markov Chaim Monte Carlo (MCMC) algorithm may be applied. The Langevin MCMC algorithm may be based on a use of the gradient of the log-probability function with respect to x (e.g., a score function):

$${∇}_{x} log {p}_{θ} ( x ) = - {∇}_{x} {ℰ}_{θ} ( x ) - {∇}_{x} log Z ( θ ) = - {∇}_{x} {ℰ}_{θ} ( x )$$

The Langevin MCMC algorithm may then be used to sample from p_{θ}(x) by first drawing an initial sample x₀ from a given prior distribution, and then by simulating the overdamped Langevin diffusion process for K steps with size δ>0 as

$$\begin{matrix}{x}_{k + 1} = {x}_{k} + δ {∇}_{x} log {p}_{θ} ( {x}_{k} ) + \sqrt{2 δ} {ξ}_{k} \\ = {x}_{k} - δ {∇}_{x} {ℰ}_{θ} ( x ) + \sqrt{2 δ} {ξ}_{k} ,\end{matrix}$$

wherein ξₖ˜N(0, I). Furthermore, when δ→0 and K→∞, then xₖ may be guaranteed to distribute as p_{θ}(x), according to some embodiments. In addition, to even further improve accuracy, the Metropolis-Hastings algorithm may be incorporated as follows. Firstly, a quantity α may be computed such that

$$α ≡ min \{ 1 , \frac{{p}_{θ} ( {x}_{k + 1} ) q ( {x}_{k} \vert {x}_{k + 1} )}{{p}_{θ} ( {x}_{k} ) q ( {x}_{k + 1} \vert {x}_{k} )} \} ,$$

wherein q(x′|x)∝exp

$$( - \frac{1}{4 δ} {‖ {x}^{′} - x - δ {∇}_{x} log {p}_{θ} ( x ) ‖}_{2}^{2} )$$

may be defined as the transition density from x to x′. Secondly, u may be drawn from a continuous distribution on the interval [0,1] such that if u≤α, the update defined by xₖ₊₁=xₖ+δ∇ₓ log p_{θ}(xₖ)+\sqrt{2δ}ξₖ=xₖ−δ∇ₓε_{θ}(x)+\sqrt{2δ}ξₖ may be applied. Otherwise, xₖ₊₁ may be set as xₖ₊₁=xₖ.

In some embodiments, and in order to further define Bayesian learning techniques for energy-based models used herein, an adaptive pre-conditioning method based on a diagonal approximation of the second order moment of gradient may be applied, which may also be referred to herein as an adaptively pre-conditioned SGLD. As such, a generalizability of SGLD and the training speed of adaptive first order methods may be additionally be applied. By initializing μ₀=0 and C₀=0, [symbol] (θₜ) may be defined as

$$g ( {θ}_{t} ) ≡ \frac{N}{n} {\sum }_{i = 1}^{n} {∇}_{{θ}_{t}} log {p}_{{θ}_{t}} ( {x}_{{t}_{i}} ) .$$

Then, at least time step t, the following updates may be performed. Firstly, a momentum update may be computed as

$${μ}_{t} ↦ {ρμ}_{t - 1} + ( 1 - ρ ) g ( {θ}_{t} ) ,$$

followed by a Cₜ update

$${C}_{t} ↦ ρ {C}_{t - 1} + ( 1 - ρ ) ( g ( {θ}_{t} ) - {μ}_{t} ) ( g ( {θ}_{t} ) - {μ}_{t - 1} ) .$$

Secondly, a parameter update may then be computed as

$${θ}_{t + 1} = {θ}_{t} - \frac{{ϵ}_{t}}{2} N ( \frac{1}{n} {\sum }_{i = 1}^{n} {∇}_{{θ}_{t}} {ℰ}_{{θ}_{t}} ( {x}_{{t}_{i}} ) - {𝔼}_{x \sim {p}_{{θ}_{t}} ( x )} [ {∇}_{{θ}_{t}} {ℰ}_{{θ}_{t}} ( x ) ] ) + ψ {ξ}_{t} ,$$

wherein ξₜ˜N(μₜ, Cₜ), and ψ may be defined as a noise parameter.

In some embodiments, and in order to further define Bayesian learning techniques for energy-based models used herein, gradient descent-based techniques may be used to compute an estimate of the maximum of the posterior distribution p_{θ}(x) as defined above (e.g., instead of using stochastic Langevin-like dynamics for parameters). In such embodiments, information-geometric optimizers may be applied for such gradient-based training of energy-based models. The following paragraphs detail how to perform natural gradient descent for energy-based models.

In some embodiments, when applying the natural gradient descent algorithm to energy based models, the parameters may be updated as follows

$${θ}_{j + 1} = {θ}_{j} - \frac{1}{{λ}_{j}} {𝒥}^{+} ( {θ}_{j} ) ( {∇}_{{θ}_{j}} {ℰ}_{{θ}_{j}} ( x ) - {𝔼}_{x \sim {p}_{{θ}_{j}} ( x )} [ {∇}_{{θ}_{j}} {ℰ}_{{θ}_{j}} ( x ) ] ) ,$$

wherein 1/λⱼ may be defined as the learning rate and [symbol] ³⁰ (θ) may be defined as the Moore-Penrose pseudo-inverse of the information matrix [symbol] (θ).

A calculation of the Bogoliubov-Kubo-Mori (BKM) metric, [symbol] ^{BKM}(θ), may additionally be computed as follows, wherein the BKM metric may be defined as a special selection of the metric [symbol] (θ) and may produce asymptotic optimality criteria.

$${{𝒥}^{BKM} ( θ )}_{j , k} = \int ( {\partial }_{{θ}_{j}} {p}_{θ} ( x ) ) ( {\partial }_{{θ}_{k}} log {p}_{θ} ( x ) ) dx ,$$

$$wherein {p}_{θ} ( x ) = exp ( - {ℰ}_{θ} ( x ) ) / Z ( θ ) .$$

Furthermore, the term ∂_{θ}_{ⱼ}p_{θ}(x) may be computed as

$${\partial }_{{θ}_{j}} {p}_{θ} ( x ) = ( {𝔼}_{z \sim {p}_{θ} ( z )} [ {\partial }_{{θ}_{j}} {ℰ}_{θ} ( z ) ] - {\partial }_{{θ}_{j}} {ℰ}_{θ} ( x ) ) {p}_{θ} ( x ) ,$$

and the term ∂_{θ}_{ₖ} log p_{θ}(x) may be computed as

$${\partial }_{{θ}_{k}} log {p}_{θ} ( x ) = ( - {\partial }_{{θ}_{k}} {ℰ}_{θ} ( x ) + {𝔼}_{y \sim {p}_{θ} ( y )} [ {\partial }_{{θ}_{k}} {ℰ}_{θ} ( y ) ] ) ,$$

leading to [symbol] ^{BKM}(θ)_{j,k} being rewritten as

$${{𝒥}^{BKM} ( θ )}_{j , k} = {𝔼}_{x \sim {p}_{θ} ( x )} [ {\partial }_{{θ}_{j}} {ℰ}_{θ} ( x ) {\partial }_{{θ}_{k}} {ℰ}_{θ} ( x ) ] - {𝔼}_{x \sim {p}_{θ} ( x )} [ {\partial }_{{θ}_{j}} {ℰ}_{θ} ( x ) ] {𝔼}_{y \sim {p}_{θ} ( y )} [ {\partial }_{{θ}_{k}} {ℰ}_{θ} ( y ) ] .$$

In some embodiments applying the BKM metric, the sampling operations utilized by [symbol] ^{BKM}(θ)_{j,k} may be computed efficiently when implemented using a thermodynamic chip architecture, such as those described herein. Furthermore, the matrix defined in the equation above for [symbol] ^{BKM}(θ)_{j,k} may be sparsified when applying a block diagonal approximation, a KFAC, or a diagonal approximation, according to some embodiments. Such techniques may reduce the number of matrix elements to be estimated using the given thermodynamic chip architecture, and may additionally lead to similar performance and gradient descent dynamics.

In some embodiments, and in order to further define Bayesian learning techniques for energy-based models used herein, additional gradient descent-based techniques may be used to compute an estimate of the maximum of the posterior distribution p_{θ}(x) as defined above. The following paragraphs detail how to perform mirror descent for energy-based models.

In some embodiments, when applying the mirror descent algorithm to energy based models, the parameters may be updated as follows for values k=1, 2, . . . , K and for a given j:

$${θ}_{j}^{k + 1} = {θ}_{j}^{k} - {η}_{k} ( {∇}_{{θ}_{j}} log {p}_{{θ}_{j}} ( x ) + {λ}_{j} {∇}_{θ} D ( {p}_{θ} ( x ) ‖ {p}_{{θ}_{j}} ( x ) ) {\vert}_{θ = {θ}_{j}^{k}} ) ,$$

wherein ηₖ and λⱼ may be defined as learning rates. The parameters may then be updated as θⱼ₊₁←θⱼ^{K+1}. Furthermore, the relative entropy term D(p_{θ}(x)∥p_{θ}_{ⱼ}(x)) may be defined as

$$D ( {p}_{θ} ( x ) ‖ {p}_{{θ}_{j}} ( x ) ) = \int {p}_{θ} ( x ) ( log {p}_{θ} ( x ) - log {p}_{{θ}_{j}} ( x ) ) dx ,$$

which may then be rewritten as the following when using the expression of the probability density for energy-based models

$$D ( {p}_{θ} ( x ) ‖ {p}_{{θ}_{j}} ( x ) ) = \int {p}_{θ} ( x ) ( {ℰ}_{{θ}_{j}} ( x ) - {ℰ}_{θ} ( x ) ) dx + log ( \frac{Z ( {θ}_{j} )}{Z ( θ )} ) .$$

In addition, in order to compute the gradient of the relative entropy term D(p_{θ}(x)∥p_{θ}_{ⱼ}(x), the gradient of the term log

$$( \frac{Z ( {θ}_{j} )}{Z ( θ )} )$$

may be computed as

$${∇}_{θ} log ( \frac{Z ( {θ}_{j} )}{Z ( θ )} ) = - \frac{{∇}_{θ} Z ( θ )}{Z ( θ )} = {𝔼}_{x \sim {p}_{θ} ( x )} [ {∇}_{θ} {ℰ}_{θ} ( x ) ] ,$$

while the gradient of the term ∫p_{θ}(x)(ε_{θ}_{ⱼ}(x)−ε_{θ}(x)) dx may be computed as

$${∇}_{θ} \int {p}_{θ} ( x ) ( {ℰ}_{{θ}_{j}} ( x ) - {ℰ}_{θ} ( x ) ) dx = - \int ( {p}_{θ} ( x ) {∇}_{θ} {ℰ}_{θ} ( x ) + {p}_{θ} ( x ) \frac{{∇}_{θ} Z ( θ )}{Z ( θ )} ) ( {ℰ}_{{θ}_{j}} ( x ) - {ℰ}_{θ} ( x ) ) dx - {𝔼}_{x \sim {p}_{θ} ( x )} [ {∇}_{θ} {ℰ}_{θ} ( x ) ] = - {𝔼}_{x \sim {p}_{θ} ( x )} [ {∇}_{θ} {ℰ}_{θ} ( x ) ( {ℰ}_{{θ}_{j}} ( x ) - {ℰ}_{θ} ( x ) ) ] + {𝔼}_{x \sim {p}_{θ} ( x )} [ {∇}_{θ} {ℰ}_{θ} ( x ) ] {𝔼}_{y \sim {p}_{θ} ( y )} [ {ℰ}_{{θ}_{j}} ( y ) - {ℰ}_{θ} ( y ) ] - {𝔼}_{x \sim {p}_{θ} ( x )} [ {∇}_{θ} {ℰ}_{θ} ( x ) ] .$$

Therefore, the gradient of the relative entropy term D(p_{θ}(x)∥p_{θ}_{ⱼ}(x)) itself may be written as

$${∇}_{θ} D ( {p}_{θ} ( x ) ‖ {p}_{{θ}_{j}} ( x ) ) = {𝔼}_{x \sim {p}_{θ} ( x )} [ {∇}_{θ} {ℰ}_{θ} ( x ) ] {𝔼}_{y \sim {p}_{θ} ( y )} [ {ℰ}_{{θ}_{j}} ( y ) - {ℰ}_{θ} ( y ) ] - {𝔼}_{x \sim {p}_{θ} ( x )} [ {∇}_{θ} {ℰ}_{θ} ( x ) ( {ℰ}_{{θ}_{j}} ( x ) - {ℰ}_{θ} ( x ) ) ] .$$

As further explained herein with regard to sampling operations of a thermodynamic chip architecture, said architecture may provide a speedup of the implementation of the mirror descent algorithm, according to some embodiments.

As introduced above, an implementation of an engineered Hamiltonian into a thermodynamic chip may include non-visible neurons. As such, the equations provided above with regard to θₜ₊₁ may be rewritten to incorporate said non-visible neurons, according to some embodiments. The following paragraphs further detail the incorporation of non-visible neurons into equations regarding θₜ₊₁.

Firstly, the parameters may be updated as

$${θ}_{t + 1} = {θ}_{t} + \frac{{ϵ}_{t}}{2} ( \frac{N}{n} {\sum }_{i = 1}^{n} {∇}_{{θ}_{t}} log {\sum }_{{z}_{n}} {p}_{{θ}_{t}} ( {x}_{{t}_{i}} , {z}_{n} ) ) + {η}_{t} ,$$

wherein p_{θ}(x, z)=exp(−ε_{θ}(x, z))/Z(θ), and

$${\sum }_{z} {p}_{θ} ( {x}_{n} , z ) = \frac{Z ( θ , {x}_{n} )}{Z ( θ )}$$

such that data may be clamped to xₙ. Furthermore,

$${∇}_{θ} log {\sum }_{{z}_{n}} {p}_{θ} ( {x}_{i} , {z}_{n} ) = - {𝔼}_{z \sim {p}_{θ} ( z \vert {x}_{i} )} [ {∇}_{θ} {ℰ}_{θ} ( {x}_{i} , z ) ] + {𝔼}_{( x , z ) \sim {p}_{θ} ( x , z )} [ {∇}_{θ} {ℰ}_{θ} ( x , z ) ] .$$

Applying the above definitions, the parameter update definition for θₜ₊₁ may then be rewritten to incorporate non-visible neurons as follows:

$${θ}_{t + 1} = {θ}_{t} + \frac{{ϵ}_{t}}{2} N ( \frac{1}{n} {\sum }_{i = 1}^{n} {𝔼}_{z \sim {p}_{{θ}_{t}} ( z \vert {x}_{i} )} [ {∇}_{{θ}_{t}} {ℰ}_{{θ}_{t}} ( {x}_{{t}_{i}} , z ) ] - {𝔼}_{( x , z ) \sim {p}_{{θ}_{t}} ( x , z )} [ {∇}_{{θ}_{t}} {ℰ}_{{θ}_{t}} ( x , z ) ] ) + {η}_{t} .$$

Such a parameter update definition indicates that z may be sampled from the posterior distribution when clamping the visible nodes to the data and according to the term θₜ, and further indicates, according to the second term, that both x and z may be sampled from the posterior distribution.

In addition, the Langevin MCMC algorithm, as introduced above, may then indicate that x may be sampled from the distribution p_{θ}(x). Therefore, when implementing non-visible neurons, the Langevin MCMC update rules may be rewritten as follows such that samples occurs over the non-visible neurons:

$$\begin{matrix}{x}_{k + 1} = {x}_{k} + δ {∇}_{x} log {p}_{θ} ( {x}_{k} ) + \sqrt{2 δ} {ξ}_{k} \\ = {x}_{k} + δ {∇}_{x} {\sum }_{z} log {p}_{θ} ( {x}_{k} , z ) + \sqrt{2 δ} {ξ}_{k} \\ = {x}_{k} + δ ( \frac{{∇}_{x} Z ( θ , {x}_{k} )}{Z ( θ , {x}_{k} )} ) + \sqrt{2 δ} {ξ}_{k} \\ = {x}_{k} - δ ( {\sum }_{z} \frac{exp ( - {ℰ}_{θ} ( {x}_{k} , z ) )}{Z ( θ , {x}_{k} )} {∇}_{x} {ℰ}_{θ} ( {x}_{k} , z ) ) + \sqrt{2 δ} {ξ}_{k} \\ = {x}_{k} - {δ𝔼}_{z \sim {p}_{θ} ( z \vert {x}_{k} )} [ {∇}_{x} {ℰ}_{θ} ( {x}_{k} , z ) ] + \sqrt{2 δ} {ξ}_{k} ,\end{matrix}$$

wherein a random variable ξₖ may be defined as ξₖ˜N (0, I). It should be noted that during inference (once the weights and biases of the engineered Hamiltonian have been learned) it is not necessary to sample the non-visible neurons (labeled z in the above equation) in order to generate inferences. However, during training (e.g. during the process of learning the weights and biases) samples of the non-visible neurons may be collected and used to compute the relevant gradients on the ASIC/FPGA.

In some embodiments, and in order to further define Bayesian learning techniques for energy-based models used herein, consideration may also be given for the negative phase term

$$- {𝔼}_{x \sim {p}_{{θ}_{t}} ( x )} [ {∇}_{{θ}_{t}} {ℰ}_{{θ}_{t}} ( x ) ]$$

in above iterations of definitions for θₜ₊₁. For example, said negative phase term may be approximated using a time series average, which may be well suited for a physics-based implementation of definitions for θₜ₊₁, according to some embodiments. In such an example, the negative phase term may be rewritten as

$${𝔼}_{x \sim {p}_{{θ}_{t}} ( x )} [ {∇}_{{θ}_{t}} {ℰ}_{{θ}_{t}} ( x ) ] \approx \frac{1}{T} {\sum }_{i = 1}^{T} {∇}_{{θ}_{t}} {ℰ}_{{θ}_{t}} ( {x}_{i} ) ,$$

wherein xᵢ may be computed from the Langevin MCMC process introduced above, or from a general Langevin dynamical evolution with finite friction, and T may be defined as a total number of time steps used in the approximation of the negative phase term. It may also be noted that, rather than summing over multiple paths sampled from the Langevin MCMC process (e.g., defined as the space average for the negative phase term), the above approximation of the negative phase term defines a summation over a single path evolving through time following the Langevin MCMC update rules. A space average implementation of the negative phase term may instead be written as

$${𝔼}_{x ∼ {p}_{{θ}_{t}} ( x )} [ {∇}_{{θ}_{t}} {ε}_{{θ}_{t}} ( x ) ] \approx \frac{1}{M} {\sum }_{i = 1}^{M} {∇}_{{θ}_{t}} {ε}_{{θ}_{t}} ( {x}_{i}^{( T )} ) ,$$

wherein there are M independent paths, and the xᵢ^{(T)} terms may be computed via definitions for xₖ₊₁ introduced above and after performing a given T number of iterations.

Therefore, for a time average approach, the parameter updates may be rewritten as

$${θ}_{t + 1} = {θ}_{t} - \frac{{ϵ}_{t}}{2} N ( \frac{1}{n} {\sum }_{i = 1}^{n} {∇}_{{θ}_{t}} {ε}_{{θ}_{t}} ( {x}_{{t}_{i}} ) - \frac{1}{T} {\sum }_{i = 1}^{T} {∇}_{{θ}_{t}} {ε}_{{θ}_{t}} ( {x}_{i} ) ) + {η}_{t} .$$

As additionally detailed below, consideration as to the initialization of xᵢ in the equation above may be given at each iteration t, as the impacts of such selections are non-trivial. In some embodiments, time averages can also be used for parameter updates when using non-visible neurons. In such as case, the hidden (latent) variables may be sampled through time to compute the relevant gradients.

### Implementations of Thermodynamic Computing Systems

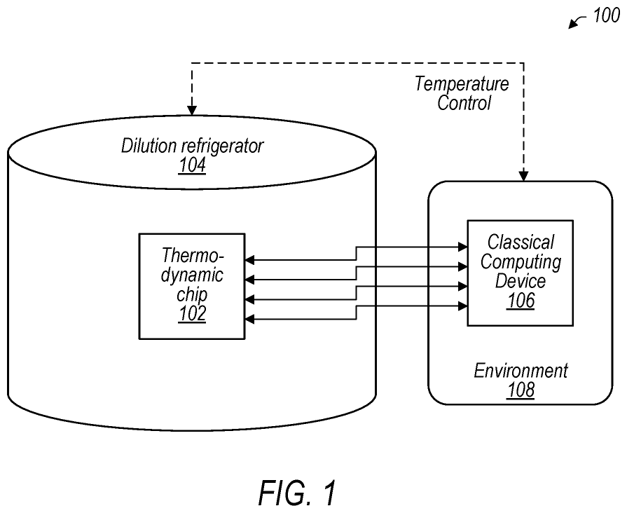

FIG. 1 is high-level diagram illustrating a thermodynamic chip included in a dilution refrigerator and coupled to a classical computing device in an environment (which may be in the dilution refrigerator or external to the dilution refrigerator), according to some embodiments.

In some embodiments, a thermodynamic computing system 100 (as shown in FIG. 1) may include a thermodynamic chip 102 placed in a dilution refrigerator 104. In some embodiments, classical computing device 106 may control oscillation frequencies of the oscillators of thermodynamic chip 120, as well as control temperature for dilution refrigerator 104. Additionally, classical computing device 106 may perform learning operations to determine weights and biases to be used in an engineered Hamiltonian implemented using oscillators of thermodynamic chip 102. In some embodiments, classical computing device 102 may be implemented in an environment 108 which may be external (or in some embodiments internal) to dilution refrigerator 104.

As introduced above, an implementation of an engineered Hamiltonian into a thermodynamic chip, such as thermodynamic chip 120, for performing Bayesian learning tasks regarding energy-based models may be defined via terms representing visible neurons, non-visible neurons, and coupling terms between the weights and biases and the visible and non-visible neurons. For example, such a thermodynamic computing system 100 may be used to train an energy-based model applied to a graph-based architecture g={V, ε}, wherein V represents a set of vertices (e.g., nodes), and ε represents a set of edges. In such implementations, neurons may reside on the nodes of the graph, each accompanied by a bias, while the synapses (weights) may reside on the edges of the graph. As additionally introduced above, an engineered Hamiltonian that may be used to derive the potential energy function used in an energy-based model, such as those applied herein, may therefore be written as

$${H}_{total} = {\sum }_{j ∈ {𝒱}_{vis}} ( \frac{{p}_{{n}_{j}}^{2}}{2 {m}_{n}^{( 𝒱 )} ( t )} + {{λ}_{n}^{( 𝒱 )} ( 1 - {ω}_{n}^{( 𝒱 )} {q}_{{n}_{j}}^{2} )}^{2} ) + {\sum }_{j ∈ {𝒱}_{non - vis}} ( \frac{{p}_{{n}_{j}}^{2}}{2 {m}_{n}^{( h )} ( t )} + {{λ}_{n}^{( h )} ( 1 - {ω}_{n}^{( h )} {q}_{{n}_{j}}^{2} )}^{2} ) + ( α {\sum }_{\{ k , l \} ∈ ε} {q}_{{s}_{kl}} {q}_{{n}_{k}} {q}_{{n}_{l}} + β {\sum }_{j ∈ 𝒱} {q}_{{n}_{j}} {q}_{{b}_{j}} ) .$$

In the Hₜₒₜₐₗ definition above, it may be noted that neurons are linearly coupled to the weights, which are defined as qₛ_{ₖₗ}, and to the biases, which are defined as q_{b}_{ⱼ}. Furthermore, [symbol] may be partitioned into sets of visible neurons, [symbol] ᵥᵢₛ, and non-visible neurons, [symbol] ₙₒₙ₋ᵥᵢₛ, wherein visible neurons may have different masses and/or frequencies than those of the non-visible neurons, according to some embodiments.

In some embodiments, as opposed to describing the engineered Hamiltonian via linear couplings between respective weights and neurons, the engineered Hamiltonian may be described using quadratic couplings. For example, the engineered Hamiltonian may be written as

$${H}_{total} = {\sum }_{j ∈ {𝒱}_{vis}} ( \frac{{p}_{{n}_{j}}^{2}}{2 {m}_{n}^{( 𝒱 )} ( t )} + {{λ}_{n}^{( 𝒱 )} ( 1 - {ω}_{n}^{( 𝒱 )} {q}_{{n}_{j}}^{2} )}^{2} ) + {\sum }_{j ∈ {𝒱}_{non - vis}} ( \frac{{p}_{{n}_{j}}^{2}}{2 {m}_{n}^{( h )} ( t )} + {{λ}_{n}^{( h )} ( 1 - {ω}_{n}^{( h )} {q}_{{n}_{j}}^{2} )}^{2} ) + ( α {\sum }_{\{ k , l \} ∈ ε} {{q}_{{s}_{kl}} ( {q}_{{n}_{k}} - {q}_{{n}_{l}} )}^{2} + β {\sum }_{j ∈ 𝒱} {( {q}_{{n}_{j}} - {q}_{{b}_{j}} )}^{2} ) .$$

In this respective Hₜₒₜₐₗ definition above, it may be noted that energy terms with regard to non-visible variables of the engineered Hamiltonian may be defined as having dual-well potentials, e.g.,

$${( 1 - {ω}_{n}^{( 𝒱 )} {q}_{{n}_{j}}^{2} )}^{2} .$$

However, in other embodiments, single-well potentials may be defined, etc. For example, in defining an engineered Hamiltonian with non-visible neurons defined via single-well potentials, the following term replacements may be made to the above Hₜₒₜₐₗ definitions:

$${\sum }_{j ∈ {𝒱}_{non - vis}} ( \frac{{p}_{{n}_{j}}^{2}}{2 {m}_{n}^{( h )} ( t )} + {{λ}_{n}^{( h )} ( 1 - {ω}_{n}^{( h )} {q}_{{n}_{j}}^{2} )}^{2} ) ↦ {\sum }_{j ∈ {𝒱}_{non - vis}} ( \frac{{p}_{{n}_{j}}^{2}}{2 {m}_{n}^{( h )} ( t )} + {{λ}_{n}^{( h )} ( {ω}_{n}^{( h )} - {q}_{{n}_{j}} )}^{2} ) .$$

A person having ordinary skill in the art should understand that, depending upon a particular application of a given thermodynamic computing system 100, single-well potentials, dual-well potentials, etc. may be preferred over other types of potentials, etc.

In addition, when performing inference and sampling using Langevin dynamics for a thermodynamic computing system 100, the Langevin MCMC update rules introduced above, e.g., xₖ₊₁, may be computed using the equation of motion for a system of particles undergoing Langevin dynamics, wherein an associated engineered Hamiltonian is defined as

$${H}_{total} = {\sum }_{j ∈ {𝒱}_{vis}} ( \frac{{p}_{{n}_{j}}^{2}}{2 {m}_{n}^{( 𝒱 )} ( t )} + {{λ}_{n}^{( 𝒱 )} ( 1 - {ω}_{n}^{( 𝒱 )} {q}_{{n}_{j}}^{2} )}^{2} ) + {\sum }_{j ∈ {𝒱}_{non - vis}} ( \frac{{p}_{{n}_{j}}^{2}}{2 {m}_{n}^{( h )} ( t )} + {{λ}_{n}^{( h )} ( 1 - {ω}_{n}^{( h )} {q}_{{n}_{j}}^{2} )}^{2} ) + ( α {\sum }_{\{ k , l \} ∈ ε} {q}_{{s}_{kl}} {q}_{{n}_{k}} {q}_{{n}_{l}} + β {\sum }_{j ∈ 𝒱} {q}_{{n}_{j}} {q}_{{b}_{j}} ) .$$

Furthermore, a person having ordinary skill in the art should understand that, if coupling terms in Hₜₒₜₐₗ may be engineered (e.g., engineered such that particles undergoing Langevin dynamics correspond to visible and non-visible neurons), inference and sampling may be implemented natively by letting said system of coupled particles evolve through time, according to some embodiments.

In order to define such an evolution, a potential energy function U_{θ}(q) may be considered (e.g., an engineered Hamiltonian such as Hₜₒₜₐₗ, without momentum-related terms), wherein visible neurons may be written as qⱼ∈ [symbol] . Furthermore, in the following definitions, θ may be used to label respective weights and biases. As such, the equation of motion for overdamped Langevin dynamics may be written as

$${dq}_{k} ( t ) = - \frac{1}{{m}_{k}} \frac{\partial {U}_{θ}}{\partial {q}_{k}} dt + \sqrt{\frac{2 {k}_{B} T}{{m}_{k}}} {dW}_{t} ,$$

wherein Wₜ is a Weiner process. To the leading order, therefore, it may be written that

$${q}_{k} ( t + δ t ) = {q}_{k} ( t ) - \frac{δ t}{{m}_{k}} \frac{\partial {U}_{θ}}{\partial {q}_{k}} + \sqrt{\frac{2 δ {tk}_{B} T}{{m}_{k}}} {η}_{t} , \\ wherein \\ {η}_{t} ∼ N ( 0 , 1 ) .$$

Next, a potential energy function may be derived that incorporates both visible and non-visible neurons. In such a derivation, a rate of change of the positions of the non-visible neurons may be regarded as faster than those of the visible neurons. As such, the equation of motion for the non-visible neurons may still be given by

$${q}_{k} ( t + δ t ) = {q}_{k} ( t ) - \frac{δ t}{{m}_{k}} \frac{\partial {U}_{θ}}{\partial {q}_{k}} + \sqrt{\frac{2 δ {tk}_{B} T}{{m}_{k}}} {η}_{t} .$$

However, in order to treat visible neurons, the equation of motion for overdamped Langevin dynamics may be rewritten as

$${x}_{k} ( t + δ t ) = {x}_{k} ( t ) - \frac{1}{{m}_{k}} {\int }_{t}^{t + δ t} \frac{\partial {U}_{θ} ( x ( τ ) , z ( τ ) )}{\partial {x}_{k}} d τ + \sqrt{\frac{2 {k}_{B} T}{{m}_{k}}} {\int }_{t}^{t + δ t} {dW}_{τ} .$$

In addition, since it may be regarded that non-visible neurons may evolve on a faster time scale than visible neurons, the term

$${\int }_{t}^{t + δ t} \frac{\partial {U}_{θ} ( x ( τ ) , z ( τ ) )}{\partial {x}_{k}} d τ$$

may be rewritten as

$${\int }_{t}^{t + δ t} \frac{\partial {U}_{θ} ( x ( τ ) , z ( τ ) )}{\partial {x}_{k}} d τ = δ t {𝔼}_{δ t} [ \frac{\partial {U}_{θ} ( x , z )}{\partial {x}_{k}} ] ,$$

wherein

$${𝔼}_{δ t} [ \frac{\partial {U}_{θ} ( x , z )}{\partial {x}_{k}} ]$$

corresponds to a time average over a length of time δt of the term

$$\frac{\partial {U}_{θ} ( x , z )}{\partial {x}_{k}} .$$

Furthermore, since weights and biases are fixed during inference, and visible neurons change by a small amount during a given time δt,

$${𝔼}_{δ t} = [ \frac{\partial {U}_{θ} ( x , z )}{\partial {x}_{k}} ]$$

may additionally be understood as an approximation to the time series average of

$${𝔼}_{{z}_{k} ∼ {p}_{θ} ( {z}_{k} \vert {x}_{k} ( t ) )} = [ \frac{\partial {U}_{θ} ( x , z )}{\partial {x}_{k}} ]$$

during the time interval [t, t+δt], e.g.,

$${𝔼}_{δ t} [ {∇}_{x} {U}_{θ} ( x , z ) ] \approx \frac{1}{δ t} {\int }_{t}^{t + δ t} {∇}_{x} {U}_{θ} ( x ( τ ) , z ( τ ) ) d τ \approx {𝔼}_{z ∼ {p}_{θ} ( z \vert x ( t ) )} [ {∇}_{x} {U}_{θ} ( x , z ) ] .$$

It may therefore be rewritten as

$${x}_{k} ( t + δ t ) = {x}_{k} ( t ) - \frac{δ t}{{m}_{k}} {𝔼}_{δ t} = [ \frac{\partial {U}_{θ} ( x , z )}{\partial {x}_{k}} ] + \sqrt{\frac{2 δ {tk}_{B} T}{{m}_{k}}} {η}_{t} .$$

The above description of an evolution through time of particles undergoing Langevin dynamics demonstrates that inference with non-visible neurons may be performed by letting a system engineered with the couplings described via Hₜₒₜₐₗ evolve through time while also ensuring that conditions defined by [symbol] _{δt}[∇ₓU_{θ}(x, z)] are satisfied. Furthermore, the definition introduced above for the equation of motion for overdamped Langevin dynamics is valid at least within the large friction limit. If, however, γ is small, the equations of motion for position and momentum may not be able to be decoupled, according to some embodiments. This may be further understood by noting that the general Langevin equations of motion for position and momentum may be written as

$${dq}_{k} ( t ) = \frac{{p}_{k} ( t )}{{m}_{k}} dt , {dp}_{k} ( t ) = \frac{\partial {U}_{θ}}{\partial {q}_{k}} dt - γ {p}_{k} ( t ) dt + σ \sqrt{{m}_{k}} {dW}_{t} ,$$

wherein σ=\sqrt{2k_{b}Tγ}. In order to solve said generalized Langevin equations, weakly second order numerical integration methods may be applied, such as the GJF method. By applying the GJF method, the equations of motion for position and momentum may be written as

$$\begin{matrix}{{{q}_{k} ( t + δ t ) = {q}_{k} ( t ) + b δ t \frac{\partial H}{\partial {p}_{k}} \vert}_{t} - \frac{{b ( δ t )}^{2}}{2 {m}_{k}} \frac{\partial H}{\partial {q}_{k}} \vert}_{t} + \frac{b {σ ( δ t )}^{3 / 2}}{2 \sqrt{{m}_{k}}} {η}_{t}^{( k )} , {p}_{k} ( t + δ t ) \\ {{= {ap}_{k} ( t ) - \frac{δ t}{2} ( a \frac{\partial H}{\partial {q}_{k}} \vert}_{t} + \frac{\partial H}{\partial {q}_{k}} \vert}_{t + δ t} ) + b σ ( \sqrt{{m}_{k} δ t} ) {η}_{t}^{( k )}\end{matrix} ,$$

wherein a and b may be written as

$$a ≡ \frac{1 - γδ t / 2}{1 + γδ t / 2} b ≡ \frac{1}{1 + γδ t / 2} .$$

It should be understood that the Langevin MCMC algorithm may be implemented using the general Langevin equations of motion for position and momentum above or the re-written versions that include the numerical integrations, as shown above.

In addition, as introduced above, certain steps during the parameter rules updates may require clamping visible neurons to the data. Such clamping operations may be configured by adding a term to

$${H}_{total} = {\sum }_{j ∈ {𝒱}_{vis}} ( \frac{{p}_{{n}_{j}}^{2}}{2 {m}_{n}^{( 𝒱 )} ( t )} + {{λ}_{n}^{( 𝒱 )} ( 1 - {ω}_{n}^{( 𝒱 )} {q}_{{n}_{j}}^{2} )}^{2} ) + {\sum }_{j ∈ {𝒱}_{non - vis}} ( \frac{{p}_{{n}_{j}}^{2}}{2 {m}_{n}^{( h )} ( t )} + {{λ}_{n}^{( h )} ( 1 - {ω}_{n}^{( h )} {q}_{{n}_{j}}^{2} )}^{2} ) + ( α {\sum }_{\{ k , l \} ∈ ε} {q}_{{s}_{kl}} {q}_{{n}_{k}} {q}_{{n}_{l}} + β {\sum }_{j ∈ 𝒱} {q}_{{n}_{j}} {q}_{{b}_{j}} )$$

such that the engineered Hamiltonian is energetically favorable for the visible nodes to take on the respective values of the data. For example, the engineered Hamiltonian may be rewritten as

$${H}_{total} = {\sum }_{j ∈ {𝒱}_{vis}} ( \frac{{p}_{{n}_{j}}^{2}}{2 {m}_{n}^{( 𝒱 )} ( t )} + {{λ}_{n , j}^{( 𝒱 )} ( 1 - {ω}_{n , j}^{( 𝒱 )} {q}_{{n}_{j}}^{2} )}^{2} ) + {\sum }_{j ∈ {𝒱}_{non - vis}} ( \frac{{p}_{{n}_{j}}^{2}}{2 {m}_{n}^{( h )} ( t )} + {{λ}_{n , j}^{( h )} ( 1 - {ω}_{n , j}^{( h )} {q}_{{n}_{j}}^{2} )}^{2} ) + ( α {\sum }_{\{ k , l \} ∈ ε} {q}_{{s}_{kl}} {q}_{{n}_{k}} {q}_{{n}_{l}} + β {\sum }_{j ∈ 𝒱} {q}_{{n}_{j}} {q}_{{b}_{j}} ) + ( ε ( t ) {\sum }_{j ∈ 𝒟 ⊆ 𝒱} {( {q}_{{n}_{j}} - {q}_{{d}_{j}} ( t ) )}^{2} ) ,$$

wherein ε(t) may be defined as a hyperparameter than may be turned on or off, and wherein q_{d}_{ⱼ}(t) may be defined as a pulse which takes on the value of the data during some time interval. In addition, the set [symbol] ⊆ [symbol] is defined as corresponding to the visible neurons of the given network architecture (see also description regarding FIGS. 5A-5D herein). Furthermore, the above engineered Hamiltonian Hₜₒₜₐₗ may be generalized by allowing λ_{n,j}^{(V)}, λ_{n,j}^{(h)}, ω_{n,j}^{(V)}, and ω_{n,j}^{(h)} to contain different values for respective potentials, according to some embodiments. For example, as further discussed with regard to deep Boltzmann machines such as that which is shown in FIG. 5D, different hyperparameters may be applied for respective restricted Boltzmann machine (RBM) blocks of a given deep Boltzmann machine, and, in addition, hyperparameters α and β may be allowed to vary across respective RBM blocks of the given deep Boltzmann machine, according to some embodiments.

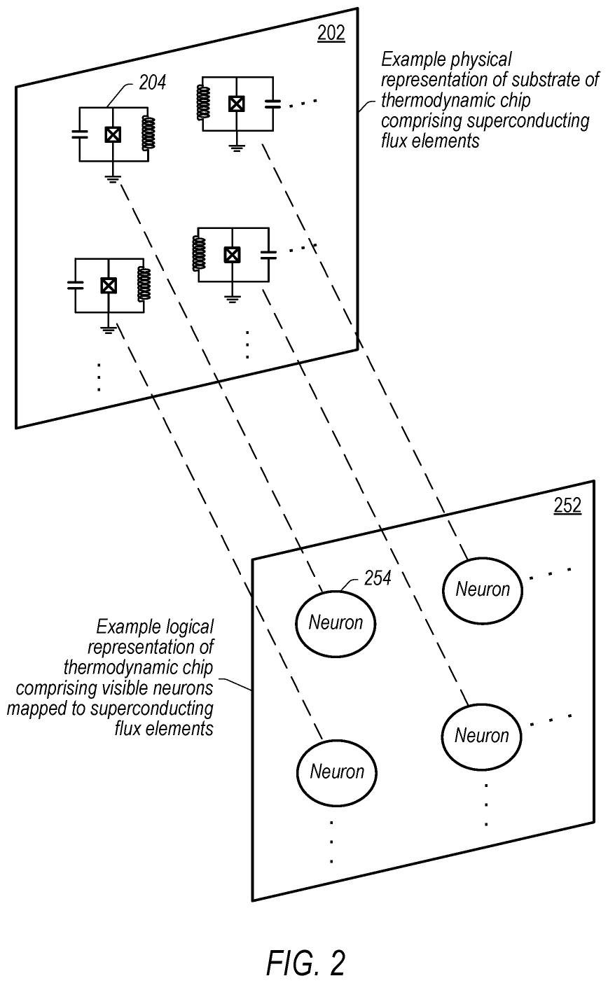

FIG. 2 is a high-level diagram illustrating oscillators included in a substrate of the thermodynamic chip and mapping of the oscillators to logical neurons of the thermodynamic chip, according to some embodiments.

In some embodiments, a substrate 202 may be included in a thermodynamic chip, such as thermodynamic chip 102. Oscillators 204 of substrate 202 may be mapped in a logical representation 252 to neurons 254. In some embodiments, oscillators 204 may include oscillators with potential ranging from a single well potential to a dual-well potential and may be mapped to visible neurons and non-visible (e.g., hidden) neurons.

In some embodiments, Josephson junctions and/or superconducting quantum interference devices (SQUIDS) may be used to implement and/or excite/control the oscillators 204. In some embodiments, the oscillators 204 may be implemented using superconducting flux elements. In some embodiments, the superconducting flux elements may physically be instantiated using a superconducting circuit built out of coupled nodes comprising capacitive, inductive, and Josephson junction elements, connected in series or parallel, such as shown in FIG. 2 for oscillator 204. However, in some embodiments, generally speaking various non-linear flux loops may be used to implement the oscillators 204, such as those having single-well potential, double-well potential, or various other potentials, such as a potential somewhere between a single-well potential and a double-well potential.

In some embodiments, non-visible neurons are not sampled. This may allow the thermodynamic chip to be configured with fewer control lines for the oscillators that are mapped to the non-visible neurons than are used for the oscillators that are mapped to the visible neurons. This may allow for scaling a thermodynamic chip to include more oscillators than would be otherwise possible if a same number of control lines were used for all oscillators.

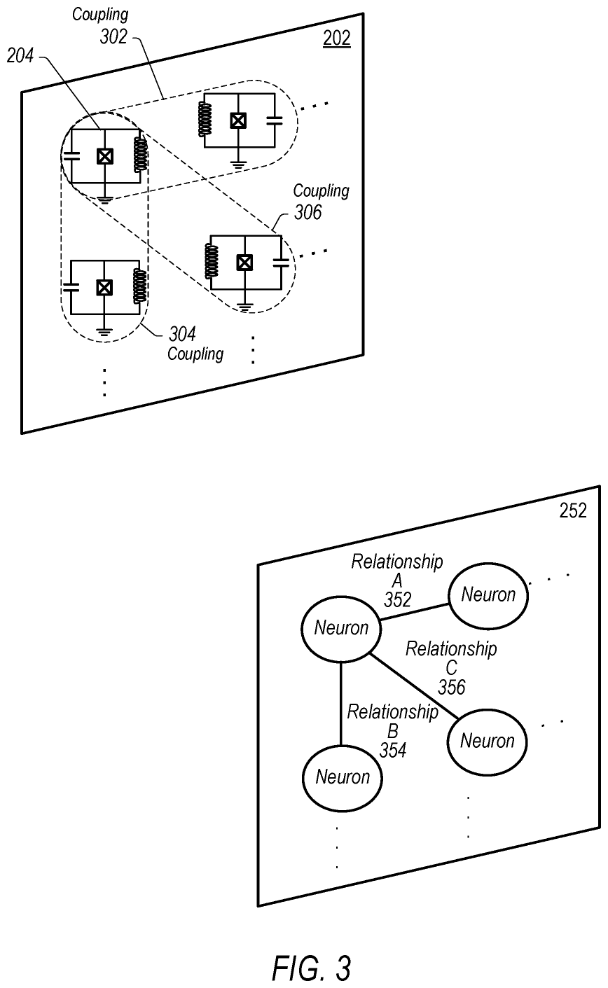

FIG. 3 is a high-level diagram illustrating logical relationships between neurons of the thermodynamic chip that are physically implemented via magnetic flux couplings between oscillators of the substrate of the thermodynamic chip, according to some embodiments.

In some embodiments, classical computing device 106 may learn relationships between respective ones of the neurons such as relationship A (352), relationship B (354), and relationship C (356). These relationships may be physically implemented in substrate 202 via couplings between oscillators 204, such as couplings 302, 304, and 306 that physically implement respective relationships 352, 354, and 356.

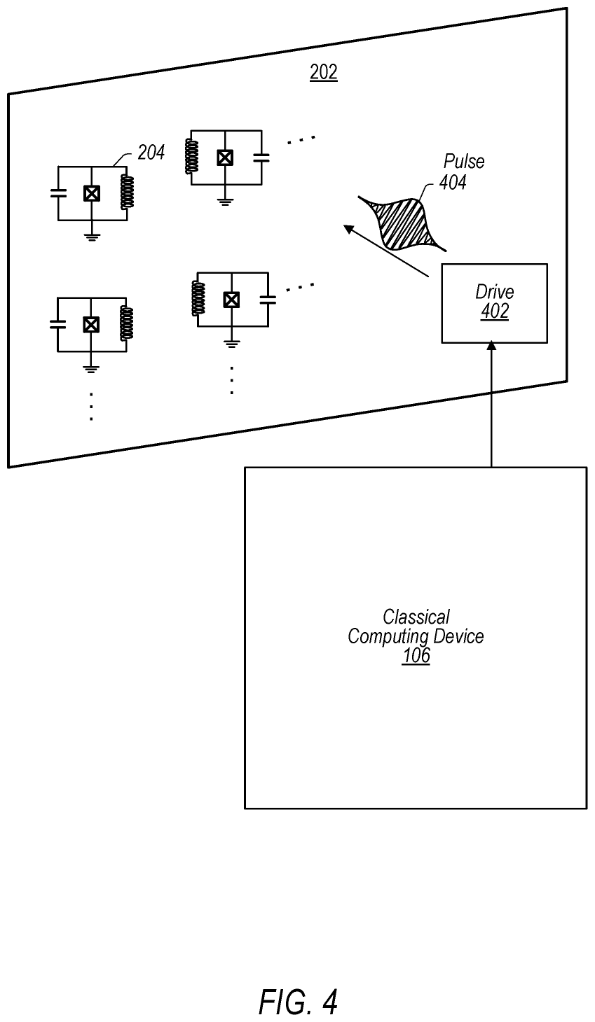

FIG. 4 is a high-level diagram illustrating a pulse drive that excites oscillators and/or implements couplings between the oscillators, according to some embodiments.

In some embodiments, a drive 402 may cause pulses 404 to be emitted to implement couplings 302, 304, and 306. Also in some embodiments, drive 402 may control a SQUID that is used to emit flux via flux lines. In some embodiments, DC signals could be used in addition to or instead of pulses 404 to implement couplings 302, 304, and 306. In general, time dependent signals may be used to control the oscillators and couplings between oscillators, wherein the time dependent signals may be implemented using various techniques.

FIG. 5A illustrates example couplings between visible input and visible output neurons of a thermodynamic chip, according to some embodiments.

In some embodiments, input neurons and output neurons, such as visible input neurons 502 and visible output neurons 504, may be directly linked via connected edges 506. As shown in FIG. 5A, a given visible input neuron 502 of the five shown in the figure is connected, via edges 506, to each of the respective three visible output neurons 504. A person having ordinary skill in the art should understand that FIG. 5A is meant to represent example embodiments of a graph architecture implemented using a thermodynamic chip that may be applied for image classification, for example, and that specific numbers of visible input neurons 502 and/or visible output neurons 504 shown in the figure are not meant to be restrictive. Additional configurations combining more/less visible input neurons 502 and/or visible output neurons 504 are also encompassed by the discussion herein. In addition, recall that neurons are logical representations of physical oscillators, such that, when describing neurons in FIGS. 5A, 5B, 5C, and 5D, it should be understood that neurons and edges are implemented using oscillators and couplings as shown in FIG. 3.

FIG. 5B illustrates example couplings between visible input neurons, non-visible neurons, and output neurons of a thermodynamic chip, according to some embodiments.

In some embodiments, FIG. 5B may resemble additional example embodiments of a graph architecture implemented using a thermodynamic chip that may be applied for image classification, for example. As shown in the figure, additional non-visible neurons 508 may be used, which are respectively coupled, via edges 506, to both visible input neurons 502 and to visible output neurons 504. Note that while the non-visible neurons are “not visible” from the perspective of inputs and outputs, the non-visible neurons may each correspond to a given oscillator, such as a given oscillator 204 as shown in FIG. 2. In addition, it may be noted that, in some embodiments that make use of non-visible neurons, no direct connections, via edges 506, may be implemented between visible input neurons 502 and visible output neurons 504, but rather connections are routed firstly via non-visible neurons 508, as shown in FIG. 5B. Couplings between visible and non-visible neurons may be additionally referred to herein as “layers” of a given architecture that is implemented using a thermodynamic chip, according to some embodiments.

FIG. 5C illustrates example couplings between visible neurons arranged according to a Hopfield network, according to some embodiments.

In some embodiments, FIG. 5C may resemble additional example embodiments of a graph architecture implemented using a thermodynamic chip that may be applied for image classification, for example. A configuration, such as those shown in FIG. 5C, may resemble a Hopfield network, wherein each respective visible neuron is connected, via edges 506, to each of the remaining visible neurons in the network. A person having ordinary skill in the art should understand that FIG. 5C is meant to represent example embodiments of a Hopfield network, and that specific numbers of visible neurons shown in the figure are not meant to be restrictive. Additional configurations connecting more/less visible neurons are also encompassed by the discussion herein, provided that each respective visible neuron is connected, via edges 506, to every other visible neuron in the network.

In some embodiments, Hopfield network configurations may be used for auto completion tasks. As an example, neurons of a Hopfield network may be mapped to pixels in an image, and a thermodynamic chip with oscillators coupled to form a physical instantiation of the logical Hopfield network (as shown in FIG. 5C) may be used to determine pixel values of pixels of an image as an example of an auto completion task. In such auto completion tasks, weights and biases may be trained by clamping each visible neuron of a fully connected graph, such as that which is shown in FIG. 5C, to pixel values of a given image. Then, during inference, a subset of the visible neurons of the fully connected graph may be clamped to a given image, while other visible neurons of the fully connected graph (e.g., unclamped neurons) may be used to reconstruct the image after one or more iterations of a Langevin MCMC algorithm, such as those which are described herein. Such applications may apply energy-based models, such as those which are described herein. For example, an engineered Hamiltonian that may be used to derive the potential energy function used in an energy-based model and subsequently applied for an auto completion task may resemble engineered Hamiltonians introduced above, such as

$${H}_{total} = {\sum }_{j ∈ {𝒱}_{vis}} ( \frac{{p}_{{n}_{j}}^{2}}{2 {m}_{n}^{( 𝒱 )} ( t )} + {{λ}_{n}^{( 𝒱 )} ( 1 - {ω}_{n}^{( 𝒱 )} {q}_{{n}_{j}}^{2} )}^{2} ) + {\sum }_{j ∈ {𝒱}_{non - vis}} ( \frac{{p}_{{n}_{j}}^{2}}{2 {m}_{n}^{( h )} ( t )} + {{λ}_{n}^{( h )} ( 1 - {ω}_{n}^{( h )} {q}_{{n}_{j}}^{2} )}^{2} ) + ( α {\sum }_{\{ k , l \} ∈ ε} {q}_{{s}_{kl}} {q}_{{n}_{k}} {q}_{{n}_{l}} + β {\sum }_{j ∈ 𝒱} {q}_{{n}_{j}} {q}_{{b}_{j}} ) .$$

FIG. 5D illustrates example couplings between visible input neurons and non-visible neurons within given layers of a deep Boltzmann machine, implemented using a thermodynamic chip, according to some embodiments.

In some embodiments, a thermodynamic computing system 100 may be used to train an energy-based model applied to a graph-based architecture such as a deep Boltzmann machine (DBM). As shown in FIG. 5D, a deep Boltzmann machine may include a first layer of visible neurons, such as visible neurons 550, along with one or more additional layers of non-visible neurons, such as non-visible neurons 554, 556, and 558, according to some embodiments. A person having ordinary skill in the art should understand that FIG. 5D is meant to represent example embodiments of a deep Boltzmann machine, implemented using a thermodynamic chip, and that specific numbers of layers of non-visible neurons shown in the figure are not meant to be restrictive. Additional configurations of a deep Boltzmann machine combining more/less non-visible neuron layers are also encompassed by the discussion herein.

As shown in FIG. 5D, a deep Boltzmann machine may include multiple “stacks” of restricted Boltzmann machines (RBMs), such as RBMs 560, 562, and 564, respectively. For example, RBM 560 includes visible neurons 550 that are connected, via edges 506, to non-visible neurons 554. Additional partitions of RBMs within the given deep Boltzmann machine, such as RBMs 562 and 564, are implemented using non-visible neurons 554, 556, and 558, as shown in the figure. A person having ordinary skill in the art should understand that, as RBMs 562 and 564 are subsequently stacked with respect to a first RBM (e.g., RBM 560), said RBMs may be implemented using layers of non-visible neurons. However, as respective RBMs within the given deep Boltzmann machine each include a layer of visible neurons and non-visible neurons, non-visible neurons 554 may act as a layer of “visible” neurons for RBM 562, while non-visible neurons 556 may act as a layer of “non-visible” neurons connected, via edges 506, to non-visible neurons 554. In addition, non-visible neurons 556 may act as a layer of “visible” neurons for RBM 564, while non-visible neurons 558 may act as a layer of “non-visible” neurons connected, via edges 506, to non-visible neurons 556.

In the following paragraphs, further detail pertaining to training a deep Boltzmann machine and performing inference is provided.

In some embodiments, a deep Boltzmann machine, such as that which is shown in FIG. 5D, may be used to train an energy-based model and, given a stacked configuration including multiple non-visible neuron layers that deep Boltzmann machines provide, complex functions may be learned using such implementations within a thermodynamic chip. Recalling the parameter update definition for θₜ₊₁ provided above that incorporates non-visible neurons, e.g.

$${θ}_{t + 1} = {θ}_{t} - \frac{{ϵ}_{t}}{2} N ( \frac{1}{n} {\sum }_{i = 1}^{n} {𝔼}_{z ∼ {p}_{{θ}_{t}} ( z \vert {x}_{i} )} [ {∇}_{{θ}_{t}} {ε}_{{θ}_{t}} ( {x}_{{t}_{i}} , z ) ] - {𝔼}_{( x , z ) ∼ {p}_{{θ}_{t}} ( x , z )} [ {∇}_{{θ}_{t}} {ε}_{{θ}_{t}} ( x , z ) ] ) + {η}_{t} ,$$

the

$${𝔼}_{z ∼ {p}_{{θ}_{t}} ( z \vert {x}_{i} )} [ {∇}_{{θ}_{t}} {ε}_{{θ}_{t}} ( {x}_{{t}_{i}} , z ) ]$$

term may indicate the positive phase term, e.g. the clamped phase, and the

$${𝔼}_{( x , z ) ∼ {p}_{{θ}_{t}} ( x , z )} [ {∇}_{{θ}_{t}} {ε}_{{θ}_{t}} ( x , z ) ]$$

term may indicate the negative phase term, e.g., the unclamped phase. Furthermore, sampling operations may be performed using the Langevin MCMC processes described herein, according to some embodiments. In addition, in the explanation of training a deep Boltzmann machine that follows, visible neurons 552 may be used to encode a given energy-based model's prediction, while other visible neurons of visible neurons 550 may be used for input data.

In some embodiments, a deep Boltzmann machine may be trained by RBM. For example, training may start with RBM 560, then proceed to training of RBM 562, and then to training of RBM 564. For clarify of notation in what follows, B₁, B₂, and B₃ refer to RBMs 560, 562, and 564, respectively, and h₁, h₂, and h₃ refer to non-visible neuron layers 554, 556, and 558, respectively.

For each epoch, the positive phase term,

$${𝔼}_{z ∼ {p}_{{θ}_{t}} ( z \vert {x}_{i} )} [ {∇}_{{θ}_{t}} {ε}_{{θ}_{t}} ( {x}_{{t}_{i}} , z ) ] .$$

may be computed, in addition to the negative phase term,

$${𝔼}_{( x , z ) ∼ {p}_{{θ}_{t}} ( x , z )} [ {∇}_{{θ}_{t}} {ε}_{{θ}_{t}} ( x , z ) ] .$$

For each input data xᵢ, non-visible nodes

$${z}_{{B}_{1}}^{( 1 , i )} \sim {p}_{θ} ( z \vert {x}_{i} )$$

may be sampled, while visible nodes are clamped to the input data. It may be noted that samples obtained from non-visible variables constrained to the non-visible layer of the given RBM being trained (e.g., non-visible neurons 554 in the case that RBM 560 is currently being trained) may be labeled herein as

$${z}_{{B}_{1}}^{( 1 , i )}$$

for each element or the given training data. Said obtained samples may then be used to compute the positive phase term

$${𝔼}_{z \sim {p}_{{θ}_{t}} ( z \vert {x}_{i} )} [ {∇}_{{θ}_{t}} {ℰ}_{{θ}_{t}} ( {x}_{{t}_{i}} , z ) ] .$$

Furthermore, in order to compute the negative phase term.

$${𝔼}_{( x , y ) \sim {p}_{{θ}_{t}} ( x , z )} [ {∇}_{{θ}_{t}} {ℰ}_{{θ}_{t}} ( x , z ) ] ,$$

results obtained from non-visible states

$${z}_{{B}_{1}}^{( 1 , i )}$$

may be used to sample visible nodes

$${x}_{{B}_{1}}^{( 1 )} \sim {p}_{θ} ( x \vert {z}_{{B}_{1}}^{( 1 , i )} ) .$$

Then, using sampled values for the visible nodes,

$${z}_{{B}_{1}}^{( 2 )} \sim {p}_{θ} ( z \vert {x}_{{B}_{1}} )$$

may be sampled. Next, x_{B}_{₁}⁽¹⁾ and z_{B}_{₁}⁽²⁾ may be used to compute the negative phase term. It may additionally be noted that sampling may be configured to alternate between

$${x}_{{B}_{1}}^{( 1 )} and {z}_{{B}_{1}}^{( 2 )}$$

multiple times, according to some embodiments. Following a computation of the positive and negative phase terms, weights and biases that are constrained to RBM 560 may be updated according to the parameter update definition for θₜ₊₁ provided above.

In some embodiments, training may then proceed to RBM 562, wherein sampled values for the non-visible nodes of RBM 560 that were computed for the positive phase term

$${z}_{{B}_{1}}^{( 1 )}$$

may be used as inputs for the visible nodes (e.g., inputs used in the non-visible neurons 554 layer of the deep Boltzmann machine shown in FIG. 5D), such that

$${z}_{{B}_{1}}^{( 1 )}$$

may now assume the role of input data xᵢ for each vector used to store the training data. Then, a process of computing the positive and negative phase terms, as described above, may be repeated. Furthermore, training may then proceed to RBM 564, and then to any further RBMs of the given deep Boltzmann machine currently being trained.

Furthermore, inference may be performed according to the Langevin MCMC update rules introduced above that account for non-visible neurons, e.g.,

$${x}_{k + 1} = {x}_{k} - {δ𝔼}_{z \sim {p}_{θ} ( z \vert {x}_{k} )} [ {∇}_{x} {ℰ}_{θ} ( {x}_{k} , z ) ] + \sqrt{2 δ} {ξ}_{k} .$$

In order to sample non-visible variables using the probability p_{θ}(z|xₖ), the following decomposition may be applied,

$${p}_{θ} ( {z}_{{h}_{1}} , {z}_{{h}_{2}} , … , {z}_{{h}_{k}} \vert {x}_{k} ) = {p}_{θ} ( {z}_{{h}_{1}} \vert {x}_{k} ) {p}_{θ} ( {z}_{{h}_{2}} \vert {z}_{{h}_{1}} , {x}_{k} ) … {p}_{θ} ( {z}_{{h}_{k}} \vert {z}_{{h}_{1}} , {z}_{{h}_{2}} , … , {z}_{{h}_{k - 1}} , {x}_{k} ) ,$$

wherein a deep Boltzmann machine may be composed of k RDMs (e.g., in FIG. 5D, a given deep Boltzmann machine is composed of 3 RDMs). Firstly, zₕ_{₁}˜p_{θ}(z|xₖ) may be sampled with xₖ clamped to a given current state of the visible nodes. Next, zₕ_{₂}˜p_{θ}(z|zₕ_{₁}, xₖ) may be sampled with zₕ_{₁} clamped to the sampled values obtained in the first RDM (e.g., RDM 560 with regard to a deep Boltzmann machine such as that shown in FIG. 5D). Such a process may proceed until the final non-visible neuron layer of the given deep Boltzmann machine is reached (e.g., non-visible neurons 558 with regard to a deep Boltzmann machine such as that shown in FIG. 5D). Then, the sampled z=(zₕ_{₁}, zₕ_{₂}, . . . , zₕ_{ₖ}) may be used to compute the gradient defined in the Langevin MCMC update rules introduced above,

$$e . g . {x}_{k + 1} = {x}_{k} - {δ𝔼}_{z \sim {p}_{θ} ( z \vert {x}_{k} )} [ {∇}_{x} {ℰ}_{θ} ( {x}_{k} , z ) ] + \sqrt{2 δ} {ξ}_{k} .$$

A person having ordinary skill in the art should understand that implementations described herein with regard to accelerating sampling steps by performing Langevin MCMC steps on a thermodynamic chip of a given thermodynamic computing system 100 may be applied to training a deep Boltzmann machine, according to some embodiments.

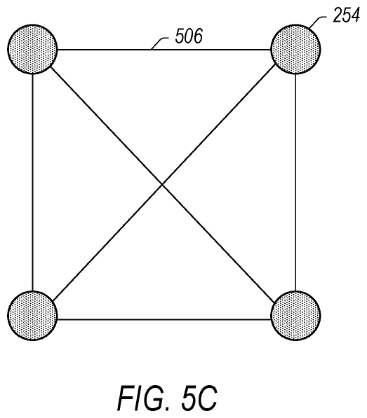

FIG. 6 illustrates an example configuration of neurons of a thermodynamic chip configured to perform space averaging, according to some embodiments.

In some embodiments, samples may be space averaged. For example, in FIG. 6 four replicas of a given engineered Hamiltonian (replicas 604, 606, 608, and 610) are implemented on a given thermodynamic chip 602. In this way, the engineered Hamiltonian may be permitted to evolve according to Langevin dynamics and four sets of results may be sampled and averaged using a space averaging technique. In some embodiments, space averaging may also be performed by initializing and evolving the same Hamiltonian under the same frequency and temperature conditions n number of times in order to obtain n samples to be space averaged. In some embodiments, space averaging may be implemented using a persistent contrastive divergence (PCD) method or using a replay buffer method, wherein such methods may be used for initializing values of xᵢ at each gradient update step of respective weights and biases. For example, when using a replay buffer method, a row vector r of size M (where M is greater than the number of samples used to compute the space average) is initialized following some distribution. The vector xᵢ for comprising the samples for computing the space average of the negative phase term is then initialized by selecting each component of xᵢ from an element of the vector r. At the end of the Langevin MCMC evolution, for each sample from the vector r used to compute the negative phase term, the new values for xᵢ are then inserted in random columns of the vector r. These steps are then repeated (without re-initializing the vector r) for each iteration of the gradient updates for weights and biases. After multiple steps, the vector r will include a large number of columns whose values were obtained from Langevin MCMC evolution iterations. Such a process may be referred to herein as a replay buffer process for determining gradient updates when computing weights and biases.

In some embodiments, samples may be time averaged, wherein samples are taken at various times during the evolution of the system that has been configured according to the engineered Hamiltonian. In some embodiments, time averaging may involve re-initializing the system and repeating the evolution wherein the re-initialization picks up where a prior evolution left off.

In some embodiments, various initialization schemes may be used to time and/or space averaging such as: re-initializing neurons of the algorithm mapped to the oscillators of the thermodynamic chip to repeat the evolution between successive instances of performing two or more measurement operations; originally initializing neurons according to a distribution and for subsequent initializations, re-initializing the neurons to have same values as in the distribution used for the original initialization; originally initializing neurons according to a distribution and for subsequent initializations re-initializing the neurons to have same values as ending values of an immediately preceding evolution; originally initializing neurons according to a distribution and for subsequent initializations, re-initializing the neurons according to the distribution, wherein the neurons are not required to have same values as resulted from the original or a preceding distribution.

A person having ordinary skill in the art should understand that replicas 604, 606, 608, and 610 may resemble a graph-based architecture such as that which is shown in FIG. 5B. However, this example of a repetition of collections of neurons is not meant to be restrictive, and additional configurations of replicas (e.g., embodiments such as those shown in FIGS. 5A, 5C, 5D, etc.) may be alternatively selected based, at least in part, on a given application that a given thermodynamic computing system 100 is being implemented for. Furthermore, FIG. 6 is meant to incorporate various embodiments and implementations of collections of neurons such that space averaging may be performed, and therefore various graph-based architectures that represent independent graphical models that may be respectively governed by engineered Hamiltonians are also incorporated in the discussion herein.

Furthermore, additional hardware designs may be implemented such that sequential sampling, for example, may be performed. In another example, more than one thermodynamic chip may be implemented within a given thermodynamic computing system 100, according to some embodiments. In such embodiments, one or more thermodynamic chips may be dedicated to performing sampling operations, while one or more additional thermodynamic chips may be dedicated to performing inference operations.

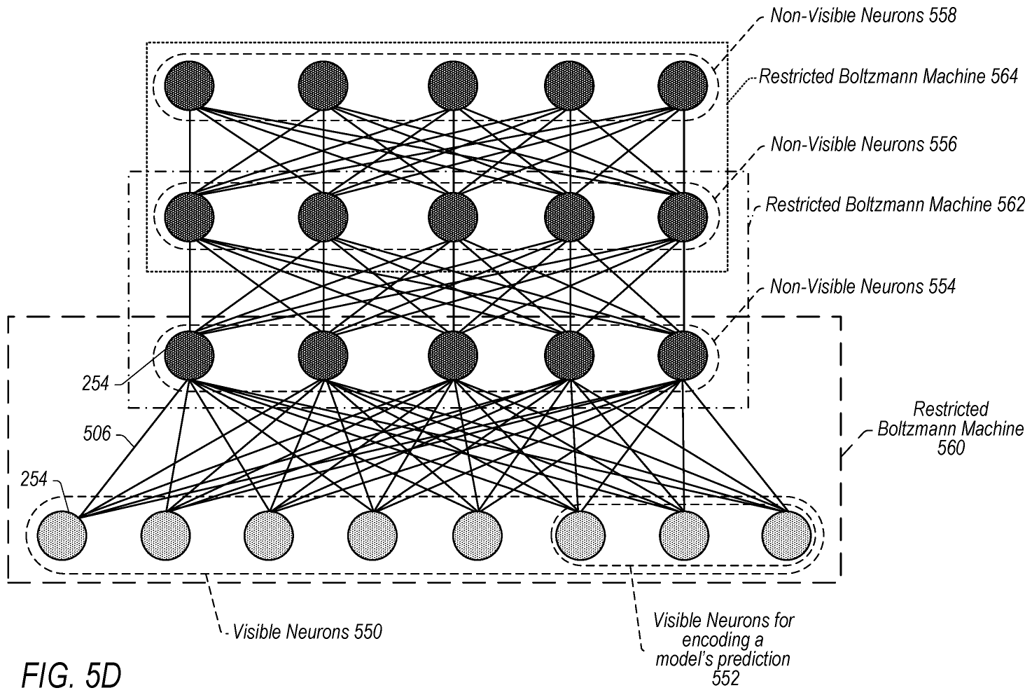

FIG. 7 illustrates an example configuration for a computing system that includes a thermodynamic chip, wherein a field-programmable gate array (FPGA) is used to interface with the thermodynamic chip, and wherein the FPGA is located in an environment external to a dilution refrigerator in which the thermodynamic chip is located, according to some embodiments.

As shown in FIG. 7, in some embodiments an FPGA 706 may be used to control thermodynamic chip 702, wherein the thermodynamic chip 702 is included in dilution refrigerator 704 and FPGA 706 is located in environment 708 external to the dilution refrigerator 704. Such hardware design implementations may be used to perform inference, for example, for a given network architecture (see also FIGS. 5A-5D) with trained weights and biases. Inference, or performing predictions on new data, may be implemented on thermodynamic chip 702, which operates in dilution refrigerator 704 at cryogenic temperatures. As additionally described above, different embodiments of network architectures may include visible neurons, or visible and non-visible neurons, which may be defined to have single and/or dual-well potentials, and may be physically implemented using superconducting flux elements and/or superconducting resonators/oscillators.

As introduced above, neurons of a set V in a given engineered Hamiltonian Hₜₒₜₐₗ may be implemented using superconducting flux elements, according to some embodiments. Superconducting flux elements may be fabricated as non-linear oscillators with either single or dual-well potentials and, as such, are applicable to terms of an engineered Hamiltonian Hₜₒₜₐₗ. Furthermore, superconducting flux elements take on continuous values in the classical limit, and the energy difference governed by oscillations between energy levels of such elements operate in the GHz regime, thus leading to faster Langevin dynamics and improved sampling and inference as performed on thermodynamic chip 702 with regard to that which could be performed using FPGA 706 (or ASIC 806).

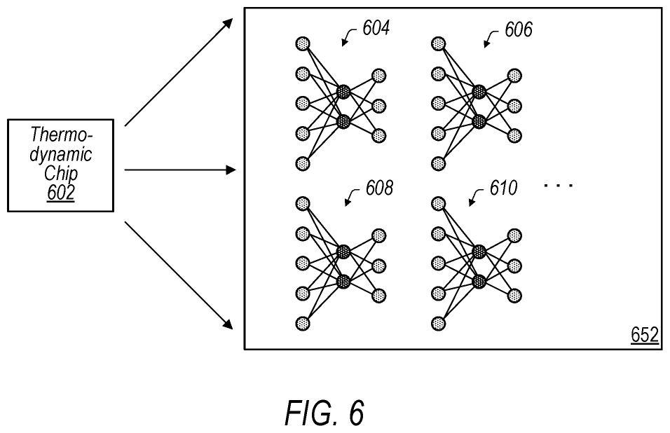

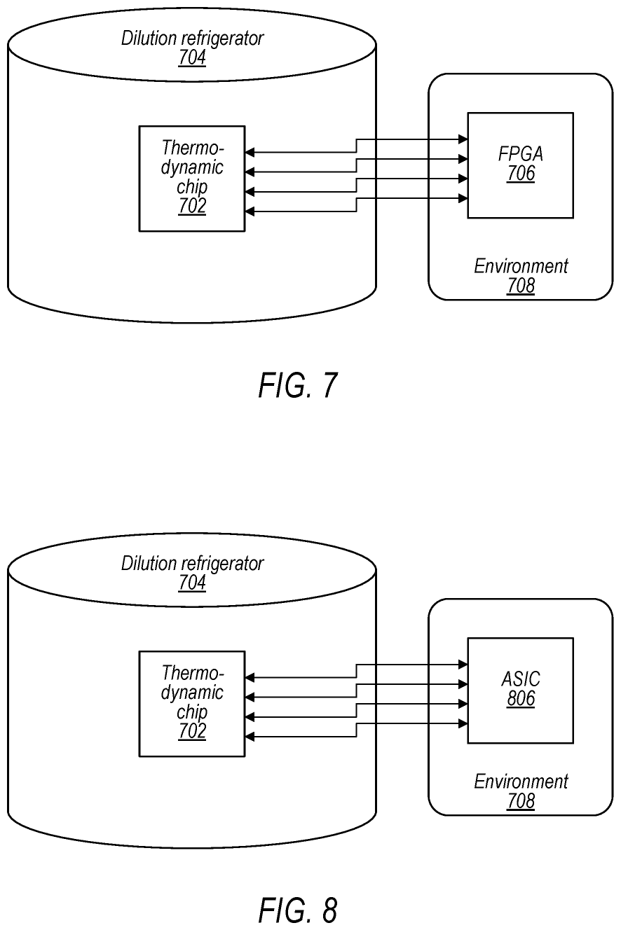

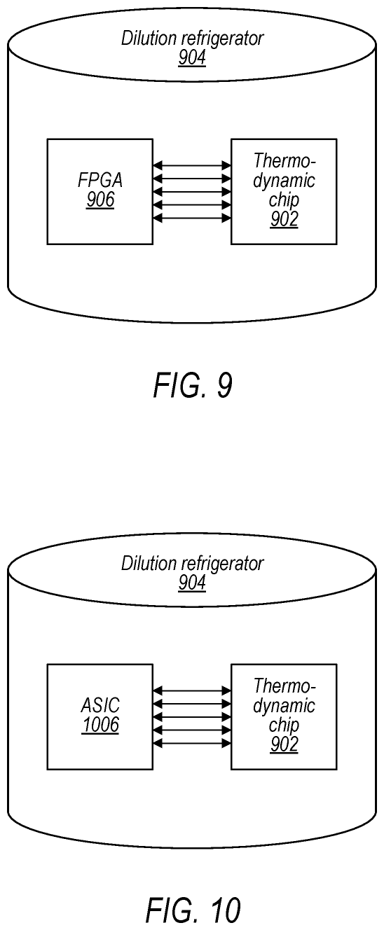

In some embodiments, for performing inference and/or sampling operations, the dynamical components of a given thermodynamic computing system 100 include neurons. Furthermore, weights and biases may be trained using an FPGA (or an ASIC, see description pertaining to FIG. 8 below) and based, at least in part, on parameter rule updates defined above. As shown in FIG. 7, FPGA 706 may be used to compute the weights and biases, and may be implemented on classical hardware operating within environment 708, wherein environment 708 may be maintained at room temperature, or may sustain cryogenic temperatures (see also description pertaining to FIGS. 9 and 10 herein).

In some embodiments, inference may be performed using hardware designs such as those which are shown in FIG. 7, wherein FPGA 706 operates at a room temperature environment 708 and computes weights and biases. Such weights and biases may then be used to construct a given engineered Hamiltonian, such as those defined above, and therefore no longer represent dynamical parameters. The given thermodynamic computing system 100 may then evolve following Langevin dynamics through time, as introduced above, wherein visible neurons are initialized according to inputs used by a given inference algorithm being applied. In addition, if a given network architecture of thermodynamic chip 702 includes non-visible neurons (see also description pertaining to FIGS. 5B and 5D herein), said non-visible neurons may be initialized randomly according to some prior distribution selected by a user of the thermodynamic computing system 100. Then, at the end of the given evolution through time, wherein the time of evolution depends on parameters of the given engineered Hamiltonian and the particular application of the thermodynamic computing system 100 being used, a readout may be performed on all visible neurons of the given network architecture, which now encode results used for performing inference. In some embodiments, such applications of a thermodynamic computing system described via FIG. 7 may be referred to as a “full inference.” In contrast, a “partial inference” may refer to avoiding an approximation of a space average term, wherein FPGA 706 may be used to perform update steps, and thermodynamic chip 702 may be used to sample z˜p_{θ}(z|xₖ), such that the sampling z˜p_{θ}(z|xₖ) is implemented exactly on thermodynamic chip 702.

FIG. 8 illustrates an example configuration for a computing system that includes a thermodynamic chip, wherein an application specific integrated circuit (ASIC) is used to interface with the thermodynamic chip, and wherein the ASIC is located in an environment external to a dilution refrigerator in which the thermodynamic chip is located, according to some embodiments.

The configuration shown in FIG. 8 is similar to that as shown in FIG. 7. However, in some embodiments an ASIC 806 may be used in place of FPGA 706.

FIG. 9 illustrates an example configuration for a computing system that includes a thermodynamic chip, wherein a field-programmable gate array (FPGA) is used to interface with the thermodynamic chip, and wherein the FPGA is co-located in a dilution refrigerator with the thermodynamic chip, according to some embodiments.

As shown in FIG. 9, in some embodiments an FPGA 906 may be used to control thermodynamic chip 902, wherein the thermodynamic chip 902 is included in dilution refrigerator 904 and FPGA 906 is co-located in dilution refrigerator 904 with thermodynamic chip 902. Such hardware design implementations may be used to perform sampling, for example, for a given network architecture (see also FIGS. 5A-5D), wherein placing both FPGA 906 and thermodynamic chip 902 in dilution refrigerator 904 may reduce potential latency times between said components. Furthermore, as described above, in some embodiments in which superconducting flux elements are used to physically implement neurons within thermodynamic chip 902, dilution refrigerator 904 may be configured to operate at cryogenic temperatures.

In some embodiments in which hardware designs such as those shown in FIG. 9 are implemented, thermodynamic chip 902 may perform sampling operations, for example, at respective iterations defined by

$${θ}_{t + 1} = {θ}_{t} - \frac{{ϵ}_{t}}{2} N ( \frac{1}{n} {\sum }_{i = 1}^{n} {∇}_{{θ}_{t}} {ℰ}_{{θ}_{t}} ( {x}_{{t}_{i}} ) - {𝔼}_{x \sim {p}_{{θ}_{t}} ( x )} [ {∇}_{{θ}_{t}} {ℰ}_{{θ}_{t}} ( x ) ] ) + {ψξ}_{t} and \\ {θ}_{t + 1} = {θ}_{t} - \frac{{ϵ}_{t}}{2} N ( \frac{1}{n} {\sum }_{i = 1}^{n} {𝔼}_{z \sim {p}_{{θ}_{t}} ( z \vert {x}_{i} )} [ {∇}_{{θ}_{t}} {ℰ}_{{θ}_{t}} ( {x}_{{t}_{i}} , z ) ] - {𝔼}_{( x , z ) \sim {p}_{{θ}_{t}} ( x , z )} [ {∇}_{{θ}_{t}} {ℰ}_{{θ}_{t}} ( x , z ) ] ) + {η}_{t} .$$

In other embodiments in which natural descent and/or mirror descent algorithms are applied, thermodynamic chip 902 may perform sampling operations, for example, at respective iterations defined by

$${{𝒥}^{BKM} ( θ )}_{j , k} = {𝔼}_{x \sim {p}_{θ} ( x )} [ {\partial }_{{θ}_{j}} {ℰ}_{θ} ( x ) {\partial }_{{θ}_{k}} {ℰ}_{θ} ( x ) ] - {𝔼}_{x \sim {p}_{θ} ( x )} [ {\partial }_{{θ}_{j}} {ℰ}_{θ} ( x ) ] {𝔼}_{y \sim {p}_{θ} ( y )} [ {\partial }_{{θ}_{k}} {ℰ}_{θ} ( y ) ] and \\ {∇}_{θ} D ( {p}_{θ} ( x ) ‖ {p}_{{θ}_{j}} ( x ) ) = {𝔼}_{x \sim {p}_{θ} ( x )} [ {∇}_{θ} {ℰ}_{θ} ( x ) ] {𝔼}_{y \sim {p}_{θ} ( y )} [ {ℰ}_{{θ}_{j}} ( y ) - {ℰ}_{θ} ( y ) ] - {𝔼}_{x \sim {p}_{θ} ( x )} [ {∇}_{θ} {ℰ}_{θ} ( x ) ( {ℰ}_{{θ}_{j}} ( x ) - {ℰ}_{θ} ( x ) ) ] .$$

Furthermore, FPGA 906 may then be used to compute weights and biases, whose results may then be used to fix qₛ_{ₖₗ} and q_{b}_{ⱼ} parameters in a given engineered Hamiltonian, as additionally described above. Next, sampling may then be performed on thermodynamic chip 902 according to Langevin dynamics and, at the end of respective sampling stages, values of the visible and non-visible neurons may be read out and passed onto FPGA 906, wherein updates are then performed according to parameter update rules defined above.

Furthermore, dilution refrigerators 704 and 904 may refer to any environment that enables at least thermodynamic chips 702 and 902 (and also FPGA 906 and/or ASIC 1006, in some embodiments as shown in FIGS. 9 and 10) to be maintained at cryogenic temperatures. Moreover, any similar environment that enables superconducting flux elements to provide functionalities described herein is meant to be included in the discussion herein, and, therefore, dilution refrigerator is not meant to be restrictive as pertaining to particular hardware of a local environment surrounding thermodynamic chips 702 and 902, as long as said functionalities of superconducting flux elements are enabled. As additionally introduced above, thermodynamic chips 702 and 902 may be considered to be “thermodynamic” because said thermodynamic chips may be operated in the thermodynamic regime slightly above 0 Kelvin, wherein thermodynamic effects cannot be ignored.

FIG. 10 illustrates an example configuration for a computing system that includes a thermodynamic chip, wherein an application specific integrated circuit (ASIC) is used to interface with the thermodynamic chip, and wherein the ASIC is co-located in a dilution refrigerator with the thermodynamic chip, according to some embodiments.

The configuration shown in FIG. 10 is similar to that as shown in FIG. 9. However, in some embodiments an ASIC 1006 may be used in place of FPGA 906.

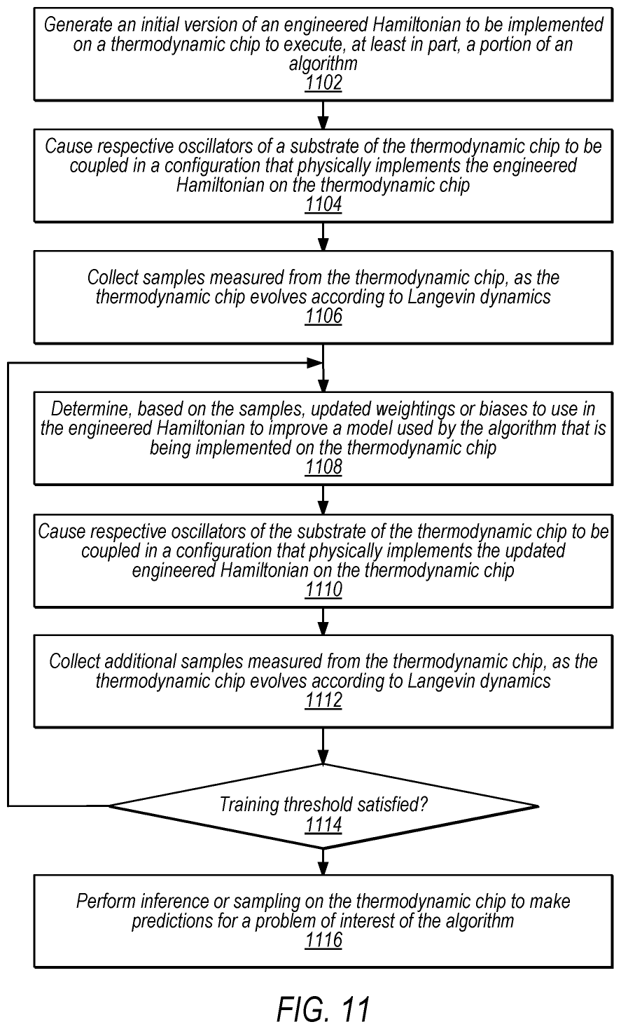

FIG. 11 illustrates a process of training and using a thermodynamic chip to perform a portion of an algorithm, according to some embodiments.

At block 1102, an initial version of an engineered Hamiltonian is generated (or received). The Hamiltonian is to be used to configure physical elements (e.g., oscillators) of a thermodynamic chip such that the physical elements evolve in an engineered way that can be sampled to execute, at least in part, a portion of an algorithm, such as a Monte Carlo sampling method embedded in a larger algorithm, or any other stochastic sampling model used in an algorithm, such as those that follow Langevin dynamics.

At block 1104, the oscillators of the substrate of the thermodynamic chip are coupled according to the engineered Hamiltonian. For example, the engineered Hamiltonian may define relationships between visible and non-visible neurons, including weightings (applied at edges between neurons) and biases applied to nodes (e.g., the neurons). For example, relationships 352, 354, and 356 as shown in FIG. 3 may be defined in the engineered Hamiltonian using weightings and biases. Also, a classical computing device (such as an FPGA or ASIC), such as classical computing device 106, as shown in FIG. 4, may cause a drive, such as drive 402 to emit pulses or other control signals that cause flux lines, such as flux lines 208 and 210, as shown in FIG. 2, to configure the respective oscillators of the substrate 202 according to the determined engineered Hamiltonian. For example, classical computing device 106 may be configured to generate a mapping between respective ones of the visible and non-visible neurons of an algorithm and respective ones of the oscillators. Continuing with said example, classical computing device 106 may then additionally generate drive instructions for drive 402 such that the oscillators will then be coupled according to the determined engineered Hamiltonian.

At block 1106, samples may be collected at one or more points during the evolution of the oscillators (that represent evolution of neurons) configured according to the engineered Hamiltonian.

At block 1108, the classical computing device (such as an FPGA or ASIC), such as classical computing device 106, as shown in FIG. 4, may determine new weightings and biases to be used in an updated version of the engineered Hamiltonian. For example, the classical computing device may perform learning to train a model implemented using the thermodynamic chip. Training a model, as is performed in various ways in other machine learning contexts, may be performed for a thermodynamic chip by adjusting weightings and biases in the engineered Hamiltonian.

At block 1108, updated weightings and biases may be determined based on the samples collected at block 1106.

At block 1110, an updated engineered Hamiltonian that has been updated to include the determined updated weightings and/or biases may be implemented on the thermodynamic chip.

At block 1112 additional samples may be collected form the thermodynamic chip with the updated engineered Hamiltonian implemented. Said updating the weights and/or biases, implementing an updated Hamiltonian including the updated weights and/or biases, and sampling the thermodynamic chip with the updated Hamiltonian implemented may be repeated until it is determined, at block 1114, that the thermodynamic chip has been sufficiently trained.

At block 1116, once the thermodynamic chip is trained, it may be used to perform a delegated portion of the algorithm, such as generating inferences or samples to be used by other components of the algorithm.

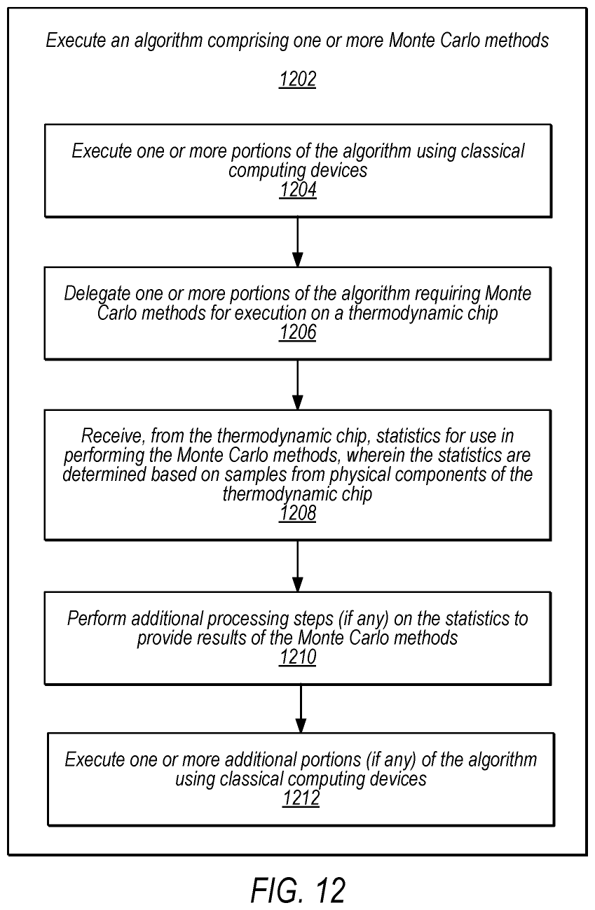

FIG. 12 illustrates a process for executing an algorithm wherein portions of the algorithm are delegated for execution using a thermodynamic chip, according to some embodiments.

In some embodiments a process of executing an algorithm including stochastic probabilities, such as may be determined via Monte Carlo sampling methods (e.g., block 1202), includes steps, such as shown in blocks 1204 through 1212.

At block 1204, one or more portions of the algorithm are executed using classical computing devices, such as processors 1310 of computer system 1300, as shown in FIG. 13.

At block 1206, one or more portions of the algorithm are delegated to be performed on a thermodynamic chip, such as thermodynamic chip 1380 (as shown in FIG. 13).

At block 1208, one or more classical computing devices, such as processors 1310, receive from the thermodynamic chip (such as thermodynamic chip 1380) statistics or other sampled values for use in performing other aspects of the algorithm. In some embodiments, statistics are obtained from the measurement of multiple neurons on a thermodynamic chip at the end of their evolution following Langevin dynamics. For example, the neurons may evolve on the thermodynamic chip following Langevin dynamics. Samples used to perform averages on classical computer may be obtained by measuring the neurons of the thermodynamic chip at the end of the evolution of the neurons. The measurement results may then be fed back to the classical computer where an average is performed (for example as discussed at block 1210).

At block 1210, a classical computing device such as FPGA or ASIC 106, performs additional post processing steps (if needed), such as time averaging, space averaging, etc. on the samples returned from the thermodynamic chip.

At block 1212, one or more classical computing devices, such as processor 1310, use the returned statistics or samples in execution of other parts of the algorithm.

### Illustrative Computer System

FIG. 13 is a block diagram illustrating an example computer system that may be used in at least some embodiments. In some embodiments, the computing system shown in FIG. 13 may be used, at least in part, to implement any of the protocols, techniques, etc. described above in FIGS. 1-12. For example, program instructions that implement protocols, techniques, etc. described herein may be stored in a non-transitory computer readable medium and/or may be executed by one or more processors, such as the processors of computer system 1300.

In the illustrated embodiment, computer system 1300 includes one or more processors 1310 coupled to a system memory 1320 (which may comprise both non-volatile and volatile memory modules) via an input/output (I/O) interface 1330. Computer system 1300 further includes a network interface 1340 coupled to I/O interface 1330. Classical computing functions may be performed on a classical computer system, such as computing computer system 1300.

Additionally, computer system 1300 includes computing device 1370 coupled to thermodynamic chip 1380. In some embodiments, computing device 1370 may be a field programmable gate array (FPGA), application specific integrated circuit (ASIC) or other suitable processing unit. In some embodiments, computing device 1370 may be a similar computing device as described in FIGS. 1-12, such as classical computing device 106, FPGA 706, ASIC 806, FPGA 906, and/or ASIC 1006. In some embodiments, thermodynamic chip 1380 may be a similar thermodynamic chip as described in FIGS. 1-12, such as thermodynamic chip 102, thermodynamic chip 202/252, thermodynamic chip 602, thermodynamic chip 702, thermodynamic chip 802, thermodynamic chip 902, and thermodynamic chip 1002.

In various embodiments, computer system 1300 may be a uniprocessor system including one processor 1310, or a multiprocessor system including several processors 1310 (e.g., two, four, eight, or another suitable number). Processors 1310 may be any suitable processors capable of executing instructions. For example, in various embodiments, processors 1310 may be general-purpose or embedded processors implementing any of a variety of instruction set architectures (ISAs), such as the x86, PowerPC, SPARC, or MIPS ISAs, or any other suitable ISA. In multiprocessor systems, each of processors 1310 may commonly, but not necessarily, implement the same ISA. In some implementations, graphics processing units (GPUs) may be used instead of, or in addition to, conventional processors.

System memory 1320 may be configured to store instructions and data accessible by processor(s) 1310. In at least some embodiments, the system memory 1320 may comprise both volatile and non-volatile portions; in other embodiments, only volatile memory may be used. In various embodiments, the volatile portion of system memory 1320 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magneto resistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 1320 as code 1325 and data 1326.

In some embodiments, I/O interface 1330 may be configured to coordinate I/O traffic between processor 1310, system memory 1320, computing device 1370, and any peripheral devices in the computer system, including network interface 1340 or other peripheral interfaces such as various types of persistent and/or volatile storage devices. In some embodiments, I/O interface 1330 may perform any necessary protocol, timing or other data transformations to convert data signals from one component (e.g., system memory 1320) into a format suitable for use by another component (e.g., processor 1310). In some embodiments, I/O interface 1330 may include support for devices attached through various types of peripheral buses, such as a variant of the Peripheral Component Interconnect (PCI) bus standard or the Universal Serial Bus (USB) standard, for example. In some embodiments, the function of I/O interface 1330 may be split into two or more separate components, such as a north bridge and a south bridge, for example. Also, in some embodiments some or all of the functionality of I/O interface 1330, such as an interface to system memory 1320, may be incorporated directly into processor 1310.

Network interface 1340 may be configured to allow data to be exchanged between computing device 1300 and other devices 1360 attached to a network or networks 1350, such as other computer systems or devices. In various embodiments, network interface 1340 may support communication via any suitable wired or wireless general data networks, such as types of Ethernet network, for example. Additionally, network interface 1340 may support communication via telecommunications/telephony networks such as analog voice networks or digital fiber communications networks, via storage area networks such as Fibre Channel SANs, or via any other suitable type of network and/or protocol.

In some embodiments, system memory 1320 may represent one embodiment of a computer-accessible medium configured to store at least a subset of program instructions and data used for implementing the methods and apparatus discussed in the context of FIG. 1 through FIG. 12. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computer system 1300 via I/O interface 1330. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computer system 1300 as system memory 1320 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 1340. Portions or all of multiple computing devices such as that illustrated in FIG. 13 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computer system”, as used herein, refers to at least all these types of devices, and is not limited to these types of devices.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or

DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures above and described herein represent exemplary embodiments of methods. The methods may be implemented in software, hardware, or a combination thereof. The order of method may be changed, and various elements may be added, reordered, combined, omitted, modified, etc.

It will also be understood that, although the terms first, second, etc., may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A method, comprising:
generating an initial version of an engineered Hamiltonian to be implemented on a thermodynamic chip to execute, at least in part, a portion of an algorithm;
causing one or more drives of the thermodynamic chip to couple respective oscillators of the thermodynamic chip in a given configuration that implements the initial version of the engineered Hamiltonian;
collecting samples measured from the oscillators, as the oscillators evolve while coupled in the given configuration that implements the initial version of the engineered Hamiltonian;
determining, based on the received samples, one or more updated weighting or bias values to be used in an updated version of the engineered Hamiltonian for performing the portion of the algorithm;
causing the one or more drives of the thermodynamic chip to couple respective ones of the oscillators in an updated configuration that implements the updated version of the engineered Hamiltonian;
collecting additional samples measured from the oscillators, as the oscillators evolve while coupled in the updated configuration that implements the updated version of the engineered Hamiltonian; and
generating one or more statistics for use in the algorithm based on the additional samples.

2. The method of claim 1, wherein:
said collecting the additional samples comprises collecting a plurality of samples during an evolution of a set of neurons of the algorithm, and
wherein the plurality of samples used in generating the one or more statistics that comprise time-averaged samples.

3. The method of claim 1, wherein said collecting the additional samples further comprises:
re-initializing neurons of the algorithm mapped to the oscillators of the thermodynamic chip to repeat the evolution between successive instances of performing the two or more measurement operations.

4. The method of claim 3, wherein:
the neurons of the algorithm are originally initialized according to a distribution; and
for subsequent initializations, the neurons are re-initialized to have same values as in the distribution used for the original initialization.

5. The method of claim 3, wherein:
the neurons of the algorithm are originally initialized according to a distribution; and
for subsequent initializations, the neurons are re-initialized to have same values as ending values of an immediately preceding evolution.

6. The method of claim 3, wherein:
the neurons of the algorithm are originally initialized according to a distribution; and
for subsequent initializations, the neurons are re-initialized according to a given distribution, wherein the neurons are not required to have same values as resulted from the original or a preceding distribution.

7. The method of claim 1, wherein said generating one or more statistics for use in the algorithm based on the additional samples comprises:
space averaging one or more samples to generate the one or more statistics.

8. The method of claim 7, wherein the space averaging is performed using a replay buffer.

9. The method of claim 7, wherein the samples used for the space averaging are collected from two or more iterations of evolution and measurement of a same thermodynamic chip.

10. The method of claim 7, wherein the samples used for the space averaging are collected from one or more iterations of evolution and measurement performed using a plurality of independent sets of neurons.

11. The method of claim 1, wherein the one or more statistics generated for use in the algorithm comprise stochastic gradient results.

12. The method of claim 1, wherein the one or more statistics generated for use in the algorithm comprise second order moment of gradient results for Langevin dynamics.

13. The method of claim 1, wherein:
the one or more statistics generated for use in the algorithm comprise gradient-descent based results that estimate a maximum of a posterior distribution; and
the gradient-descent is:
a natural gradient descent; or
a mirror descent.

14. One or more non-transitory, computer-readable, storage media, storing program instructions, that when executed on or across one or more processors, cause the one or more processors to:
execute an algorithm, wherein the algorithm comprises one or more sampling methods, wherein to execute the algorithm, the program instructions further cause the one or more processors to:
delegate at least some portions of performing the sampling methods to a thermodynamic chip, wherein said delegation further causes the one or more processors to:
receive statistics for use in performing the one or more sampling methods that are sampled from physical components of the thermodynamic chip; and
provide results of the one or more sampling methods generated based on the received statistics.

15. The one or more non-transitory, computer-readable, storage media of claim 14, wherein:
the one or more sampling methods of the algorithm comprise visible and non-visible neurons; and
to delegate the at least some portions of performing the one or more sampling methods to the thermodynamic chip, the program instructions further cause the one or more processors to:
generate a mapping of respective ones of the physical components of the thermodynamic chip comprising oscillators to the visible and non-visible neurons of the one or more sampling methods of the algorithm in a given configuration that implements a trained version of an engineered Hamiltonian.

16. The one or more non-transitory, computer-readable, storage media of claim 15, wherein, to delegate the at least some portions of performing the one or more sampling methods to the thermodynamic chip, the program instructions further cause the one or more processors to:
generate drive instructions for one or more drives of the thermodynamic chip, wherein:
the drive instructions are based, at least in part, on the generated mapping; and
the drive instructions comprise instructions pertaining to pulse emissions used to cause the respective ones of the oscillators of the thermodynamic chip to be configured to implement the trained version of the engineered Hamiltonian.

17. A system, comprising:
one or more classical computing devices coupled to a thermodynamic chip, wherein the one or more classical computing devices are configured to:
generate an initial version of an engineered Hamiltonian to be implemented on the thermodynamic chip to execute, at least in part, at least a portion of a machine learning algorithm;
cause one or more drives of the thermodynamic chip to couple respective ones of oscillators of the thermodynamic chip in a given configuration that implements the initial version of the engineered Hamiltonian;
receive samples measured from the oscillators, as the oscillators evolve while coupled in the given configuration that implements the initial version of the engineered Hamiltonian;
determine, based on the received samples, one or more updated weighting or bias values to be used in an updated version of the engineered Hamiltonian for performing the at least a portion of the machine learning algorithm;
cause the one or more drives of the thermodynamic chip to couple respective ones of the oscillators in an updated configuration that implements the updated version of the engineered Hamiltonian;
receive additional samples measured from the oscillators, as the oscillators evolve while coupled in the updated configuration that implements the updated version of the engineered Hamiltonian; and
repeat said determining one or more updated weighting or bias values, said causing an updated version of the Hamiltonian including the updated weighting or bias values to be implemented on the thermodynamic chip, and said receiving additional samples from the thermodynamic chip until a current version of the engineered Hamiltonian satisfies one or more training thresholds for performing inferences for the at least a portion of the machine learning algorithm.

18. The system of claim 17, wherein:
the received additional samples comprise a plurality of samples collected during an evolution of a set of neurons of the machine learning algorithm, and
the one or more classical computing devices are further configured to:
generate one or more statistics of the machine learning algorithm based, at least in part, on time-averaged samples comprising the received samples and the received additional samples.

19. The system of claim 17, wherein:
one or more sampling methods of the machine learning algorithm comprises visible and non-visible neurons; and
to cause the one or more drives of the thermodynamic chip to couple the respective ones of oscillators of the thermodynamic chip in the given configuration that implements the initial version of the engineered Hamiltonian, the one or more classical computing devices are configured to:
generate a mapping of the respective ones of the oscillators of the thermodynamic chip to the visible and non-visible neurons of the one or more sampling methods of the machine learning algorithm in the given configuration that implements the initial version of the engineered Hamiltonian.

20. The system of claim 19, wherein to cause the one or more drives of the thermodynamic chip to couple the respective ones of oscillators of the thermodynamic chip in the given configuration that implements the initial version of the engineered Hamiltonian, the one or more classical computing devices are further configured to:
generate drive instructions for the one or more drives of the thermodynamic chip, wherein:
the drive instructions are based, at least in part, on the generated mapping; and
the drive instructions comprise instructions pertaining to pulse emissions used to cause the respective ones of the oscillators of the thermodynamic chip to be coupled to one another in the given configuration.
